(19) United States
(12) Patent Application Publication
(10) Pub. No.: US 2013/0040052 A1
(43) Pub. Date: Feb. 14, 2013

(54) PROCESS FOR PRODUCING WIRE-GRID POLARIZER, AND LIQUID CRYSTAL DISPLAY DEVICE

(71) Applicant: Asahi Glass Company, Limited, Tokyo (JP)

(72) Inventors: Yosuke AKITA, Tokyo (JP); Hiroshi Sakamoto, Tokyo (JP); Yasuhiro Ikeda, Tokyo (JP); Hiromi Sakurai, Tokyo (JP); Yuriko Kaida, Tokyo (JP)

(73) Assignee: Asahi Glass Company, Limited, Tokyo (JP)

(21) Appl. No.: 13/652,844

(22) Filed: Oct. 16, 2012

Related U.S. Application Data
(63) Continuation of application No. PCT/JP2011/059562, filed on Apr. 18, 2011.

(30) Foreign Application Priority Data
Apr. 19, 2010 (JP) 2010-095847

(51) Int. Cl. B05D 5/06

(52) U.S. Cl. 427/163.1

(57) ABSTRACT

A process for producing a wire-grid polarizer; the wire-grid polarizer comprising: a light-transmitting substrate 14 having a surface on which a plurality of ridges 12 are formed in parallel with one another at a predetermined pitch; and a first cover layer 20 comprising a metal layer 22 and a metal oxide layer 21 and covering a first side surface 16 of each ridge 12, the maximum covering thickness of the cover layer 20 in a lower region of the ridge 12 being smaller than the maximum covering thickness of the cover layer 20 in an upper region of the ridge 12; the process comprising: forming the metal layer 22 by vapor-depositing aluminum so that no oxide is formed in the metal layer; and forming the metal oxide layer 21 by vapor-depositing aluminum under the presence of oxygen so that oxygen defects are formed in the metal oxide layer 21.

This application is a continuation of PCT Application No. PCT/JP2011/059562, filed on Apr. 18, 2011, which is based upon and claims the benefit of priority from Japanese Patent Application No. 2010-095847 filed on Apr. 19, 2010. The contents of those applications are incorporated herein by reference in its entirety.

### TECHNICAL FIELD

The present invention relates to a process for producing a wire-grid polarizer, and to a liquid crystal display device having a wire-grid polarizer produced by the process.

### BACKGROUND ART

As polarizers (they are also referred to as polarizing separation elements) used for liquid crystal display devices and showing polarization separation ability in the visible light region, there are wire-grid polarizers.

A wire-grid polarizer has a construction comprising a light-transmitting substrate having a plurality of parallel fine metallic wires arranged on the substrate. When the pitch of the fine metallic wires is sufficiently shorter than the wavelength of incident light, in the incident light, a component (i.e. p-polarized light) having an electric field vector perpendicular to the fine metallic wires is transmitted, but a component (i.e. s-polarized light) having an electric field vector parallel with the fine metallic wires is reflected.

In the incident light from a backlight unit, light reflected by the wire-grid polarizer without entering the polarizer is reflected again by the backlight unit to be incident into the wire-grid polarizer again to achieve improvement of utilization efficiency of light, and accordingly, for the purpose of achieving high brightness of liquid crystal display device, a demand for wire-grid polarizers has become increased.

As wire-grid polarizers showing polarization separation ability in visible light region, the following types are known. (1) A wire-grid polarizer comprising a light-transmitting substrate on which fine metal wires are formed at a predetermined pitch (refer to Patent Document 1). (2) A wire-grid polarizer comprising a light-transmitting substrate having a surface on which a plurality of ridges are formed at a predetermined pitch and a top face and side surfaces of such a ridge is covered with a material film of a metal or a metal compound to form a fine metal wire (refer to Patent Document 2). (3) A wire-grid polarizer comprising a light-transmitting substrate having a surface on which a plurality of ridges are formed at a predetermined pitch and a plate-shaped member of a metal formed on each ridge as a fine metal wire (refer to Patent Document 4). (4) A wire-grid polarizer comprising a light-transmitting substrate having a surface on which a plurality of ridges are formed at a predetermined pitch and a metal layer formed on each ridge as a fine metal wire (refer to Patent Document 3).

However, the wire-grid polarizer of (1) has a demerit that its productivity is low since the fine metal wire is formed by lithography. In the wire-grid polarizers of (2), (3) and (4), reflection of s-polarized light occurs also on a liquid crystal panel side (viewer side of liquid crystal display device) besides a backlight unit side. Accordingly, s-polarized light reflected from the liquid crystal panel side of the wire-grid polarizer is incident into the liquid crystal panel again, and the contrast of an image displayed on the viewer side of the liquid crystal panel is deteriorated.

As a wire-grid polarizer wherein reflection on a liquid crystal panel side is suppressed, one provided with an absorber layer made of e.g. aluminum oxide on the liquid crystal panel side of the fine metal wires, is proposed (refer to Patent Document 5).

However, since aluminum oxide (Al₂O₃) is a transparent material, that is a material having an extremely high transmittance, which absorbs little light, it is not possible to sufficiently suppress reflection of s-polarized light at the liquid crystal panel side.

### PRIOR ART DOCUMENTS

### Patent Documents

Patent Document 1: JP-A-2005-070456
Patent Document 2: JP-A-2006-003447
Patent Document 3: JP-A-2005-181990
Patent Document 4: WO2006/064693
Patent Document 5: JP-A-2009-186929

### DISCLOSURE OF INVENTION

### Technical Problem

The present invention provides a process for producing a wire-grid polarizer having a high degree of polarization and a high p-polarized light transmittance, and having one surface having a high s-polarized light reflectance and the other surface having a low s-polarized light reflectance; and a liquid crystal display device having a high brightness wherein lowering of contrast is suppressed.

### Solution to Problem

The process for producing a wire-grid polarizer of the present invention is characterized by a process for producing a wire-grid polarizer; the wire-grid polarizer comprising: a light-transmitting substrate having a surface on which a plurality of ridges are formed in parallel with one another at a predetermined pitch with flat portions formed between the ridges; and a cover layer comprising a metal layer and a metal oxide layer and covering at least one side surface of each ridge, the maximum value of the covering thickness of the cover layer in a region from a half-height position to the bottom portion of the ridge being smaller than the maximum value of the covering thickness of the cover layer in a region from the half-height position to the top portion of the ridge; the process comprising: forming the metal layer by vapor-depositing aluminum so that no oxide is formed in the metal layer; and forming the metal oxide layer by vapor-depositing aluminum under the presence of oxygen so that oxygen defects are formed in the metal oxide layer.

The process for producing a wire-grid polarizer of the present invention preferably comprises a step (1R1) of vapor-depositing aluminum from a direction substantially perpendicular to the longitudinal direction of each ridge and at an angle θ^{R}₁ (°) satisfying the following formula (a) on a first side surface side to the height direction of the ridge to form the metal oxide layer or the metal layer; and a step (1R2) after the step (1R1), of vapor-depositing aluminum from a direction substantially perpendicular to the longitudinal direction of each ridge and at an angle θ^{R}₂ (°) satisfying the following formula (b) on the first side surface side to the height direction of the ridge under a condition whereby the vapor deposition amount becomes larger than that of the step (1R1), to form the metal layer or the metal oxide layer:

tan(θ^{R}₁±10)=(Pp−Dpb/2)/Hp (a)

θ^{R}₁+3≦θ^{R}₂≦θ^{R}₁+30 (b)

where Pp is the pitch of the ridges, Dpb is the width of the bottom portion of each ridge, and Hp is the height of each ridge.

Further, it is preferred that the step (1R1) is carried out under a condition whereby the vapor deposition amount becomes 4 to 25 nm, and the step (1R2) is carried out under a condition whereby the vapor deposition amount becomes 25 to 70 nm.

The process of the present invention may be a process for producing a wire-grid polarizer wherein the cover layer covers two side surfaces of each ridge, and the maximum value of the covering thickness of the cover layer in a region from the half-height position to the bottom portion of each ridge is smaller than the maximum value of the covering thickness of the cover layer in a region from the half-height position to the top portion of the ridge in each of the two side surfaces.

When the cover layer covers two side surfaces of each ridge, the process preferably comprises a step (2R1) of vapor-depositing aluminum from a direction substantially perpendicular to the longitudinal direction of each ridge and at an angle θ^{R}₁ (°) satisfying the following formula (c) on the first side surface side to the height direction of the ridge to form the metal oxide layer or the metal layer; a step (2L1) of vapor-depositing aluminum from a direction substantially perpendicular to the longitudinal direction of the ridge and at an angle θ^{L}₁ (°) satisfying the following formula (d) on the second side surface side to the height direction of the ridge to form the metal oxide layer or the metal layer; a step (2R2) after the step (2R1), of vapor-depositing aluminum from a direction substantially perpendicular to the longitudinal direction of the ridge and at an angle θ^{R}₂ (°) satisfying the following formula (e) on the first side surface side to the height direction of the ridge under a condition whereby the vapor deposition amount becomes larger than that of the step (2R1) to form the metal layer or the metal oxide layer; and a step (2L2) after the step (2L1), of vapor-depositing aluminum from a direction substantially perpendicular to the longitudinal direction of the ridge and at an angle θ^{L}₂ (°) satisfying the following formula (f) on the second side surface side to the height direction of the ridge under a condition whereby the vapor deposition amount becomes larger than that of the step (2L1), to form the metal layer or the metal oxide layer:

tan(θ^{R}₁±10)=(Pp−Dpb/2)/Hp (c)

tan(θ^{L}₁±10)=(Pp−Dpb/2)/Hp (d)

θ^{R}₁+3≦θ^{R}₂≦θ^{R}₁+20 (e)

θ^{L}₁+1≦θ^{L}₂≦θ^{L}₁+20 (f)

where Pp is the pitch of the ridges, Dpb is the width of the bottom portion of each ridge, and Hp is the height of each ridge.

Further, it is preferred that the step (2R1) and the step (2L1) are carried out under conditions whereby the vapor deposition amounts become 4 to 25 nm, and the step (2R2) and the step (2L2) are carried out under conditions whereby the vapor deposition amounts become 10 to 25 nm.

In the process for producing a wire-grid polarizer of the present invention, it is preferred that the formation of the metal oxide layer is carried out under a vapor deposition condition whereby a thin film having a transmittance T (%) and a reflectance R(%) satisfying the following formulae (j) to (m) is formed when aluminum is vapor-deposited with a vapor deposition amount of 20 nm on a flat portion:

3≦T≦90 (j)

5≦R≦90 (k)

50≦T+R≦97 (l)

90≦T+2R (m).

The process of the present invention is preferably a process for producing a wire-grid polarizer wherein the cross-sectional shape of the ridge perpendicular to the longitudinal direction of the ridge is a shape having a width narrowing from the bottom portion toward the top portion of the ridge.

It is preferred that the cross-sectional shape of the ridge perpendicular to the longitudinal direction of the ridge is a triangle or a trapezoid.

It is preferred that the ridge is made of a photocurable resin or a thermoplastic resin and is formed by an imprinting method.

The liquid crystal display device of the present invention is characterized by one which comprises: a liquid crystal panel comprising a pair of substrates and a liquid crystal layer sandwiched between the substrates; a backlight unit; and a wire-grid polarizer obtained by the process of the present invention, the wire-grid polarizer being disposed so that the surface on which the ridges are formed faces to the backlight unit, and that a surface on which no ridge is formed is on the viewer side of the liquid display device.

The liquid crystal display device of the present invention is preferably one which further comprises an absorption type polarizer, wherein the wire-grid polarizer is disposed on a surface of the liquid crystal panel, and the absorption type polarizer is disposed on a surface of the liquid crystal panel opposite from the surface on which the wire-grid polarizer is disposed.

Further, it is preferred that the wire-grid polarizer is disposed on a backlight unit-side surface of the liquid crystal panel, and the absorption type polarizer is disposed on a surface of the liquid crystal panel opposite from the backlight unit-side surface.

The liquid crystal display device of the present invention is preferably one which further comprises an absorption type polarizer, wherein the wire-grid polarizer is integrally formed with one of the pair of substrates of the liquid crystal panel, and the absorption type polarizer is disposed on a surface of the other substrate of the liquid crystal panel, that is a substrate opposite from the substrate with which the wire-grid polarizer is integrally formed.

Further, it is preferred that the wire-grid polarizer is integrally formed with the backlight unit-side substrate of the liquid crystal panel, and the absorption type polarizer is disposed on a surface of the liquid crystal panel, that is opposite from the backlight unit-side surface.

The liquid crystal display device of the present invention is preferably one which further comprises an absorption type polarizer, wherein the wire-grid polarizer is disposed on a liquid crystal layer-side surface of one of the pair of substrates of the liquid crystal panel, and the absorption type polarizer is disposed on a surface of a substrate of the liquid crystal panel opposite from the side on which the wire-grid polarizer is disposed.

Further, it is preferred that the wire-grid polarizer is disposed on a liquid crystal layer-side of a backlight unit-side substrate among the pair of substrates of the liquid crystal panel, and the absorption type polarizer is disposed on a surface the liquid crystal panel opposite from the backlight unit-side surface.

### Advantageous Effects of Invention

With the process for producing a wire-grid polarizer of the present invention, it is possible to produce with high productivity a wire-grid polarizer having a high degree of polarization and a high p-polarized light transmittance and having one surface having a high s-polarized light reflectance and the other surface having a low s-polarized light reflectance.

The liquid crystal display device of the present invention has a high brightness, and in this device, lowering of contrast is suppressed.

### BRIEF DESCRIPTION OF DRAWINGS

FIG. 1 is a perspective view showing an example of a wire-grid polarizer.

FIG. 2 is a perspective view showing another example of the wire-grid polarizer of the present invention.

FIG. 3 is a perspective view showing another example of the wire-grid polarizer of the present invention.

FIG. 4 is a perspective view showing another example of the wire-grid polarizer of the present invention.

FIG. 5 is a perspective view showing another example of the wire-grid polarizer of the present invention.

FIG. 6 is a perspective view showing another example of the wire-grid polarizer of the present invention.

FIG. 7 is a perspective view showing an example of a light-transmitting substrate.

FIG. 8 is a view showing θ^{R}₁ represented by formula (a).

FIG. 9 is a cross-sectional view showing an example of the liquid crystal display device of the present invention.

FIG. 10 is a graph showing a relation between oxygen introduction amount and transmittance (T) using vapor deposition speed as a parameter.

FIG. 11 is a graph showing a relation between oxygen introduction amount and reflectance (R) using vapor deposition speed as a parameter.

FIG. 12 is a graph showing a relation between oxygen introduction amount and absorptance (A) using vapor deposition speed as a parameter.

FIG. 13 is a triangle diagram showing a relation among transmittance (T), reflectance (R) and absorptance (A) using vapor deposition speed as a parameter.

### DESCRIPTION OF EMBODIMENTS

In this specification, a surface of a wire-grid polarizer on which ridges are formed is referred to as “front surface” and a surface on which no ridge is formed is referred to as “rear surface”.

In this specification, light-transmittance means a property of transmitting light.

In this specification, “θ±10” means a range of at least (θ−10) and at most (θ+10). This rule also applies to similar descriptions.

In this specification, “substantially perpendicular” means that an angle between a direction L and a direction V1 (or direction V2) is within a range of from 85 to 95°.

In this specification, “vapor deposition amount” means a thickness of a metal layer or a metal oxide layer formed by vapor-deposition of aluminum on a flat portion of a light-transmitting substrate on which no ridge is formed, at a time of forming the metal layer or the metal oxide layer on ridges; or the thickness of a metal layer or a metal oxide layer formed by vapor deposition of aluminum on a flat portion of a flat substrate (e.g. glass substrate) at a time of condition-setting of vapor deposition conditions.

In this specification, transmittance, reflectance and absorptance are defined as values at a measurement wavelength of 550 nm unless otherwise specified.

### <Wire-Grid Polarizer>

A wire-grid polarizer obtained by the process of the present invention is one comprising a light-transmitting substrate having a surface on which a plurality of ridges are formed in parallel with one another at a predetermined pitch with flat portions formed between the ridges; and a cover layer comprising a metal layer and a metal oxide layer, the maximum value of the covering thickness of the cover layer in a region from a half-height position to the bottom portion of the ridge being smaller than the maximum value of the covering thickness of the cover layer in a region from the half-height position to the top portion of the ridge.

### (Light-Transmitting Substrate)

The light-transmitting substrate is a substrate having a light-transmittance in a wavelength region to be used for the wire-grid polarizer. The light-transmittance means a property of transmitting light, and the wavelength region is specifically a region of from 400 nm to 800 nm. The light-transmitting substrate is one having an average light-transmittance of preferably at least 80%, more preferably at least 85% in a region of from 400 nm to 800 nm.

Each of the ridges is a portion projecting from a principal surface (flat portion) of the light-transmitting substrate, which extends in one direction. The ridges may be made of the same material as the material of the surface portion of the light-transmitting substrate and integrally formed with the portion, or it may be made of a light-transmitting material different from the material of the principal surface portion of the light-transmitting substrate. The ridges are preferably integrally formed with the principal surface of the light-transmitting substrate and made of the same material as the principal surface portion of the light-transmitting substrate. Further, the ridges are preferably formed by shaping at least the principal surface portion of the light-transmitting substrate.

It is sufficient that the plurality of ridges are formed so that corresponding side surfaces of the ridges are substantially parallel and they are not necessarily formed completely in parallel. Further, each ridge preferably has a linear shape in plan view which is the optimum shape for developing optical anisotropy, but each ridge may have a curve shape or a polygonal line shape so long as adjacent ridges do not contact to each other.

The cross-sectional shape of each ridge in a section perpendicular to the longitudinal direction of the ridge and the principal plane of the light-transmitting substrate, is preferably constant along the longitudinal direction of the ridge, and the cross-sectional shape is preferably substantially constant among a plurality of the ridges. The cross-sectional shape is preferably a shape having a width narrowing from a bottom portion (the principal surface of the light-transmitting substrate) toward the top portion. As compared with a case where the cross-sectional shape of each ridge is rectangle, it is possible to obtain more sufficient interval between ridges after formation of a cover layer, and to achieve high p-polarized light transmittance. A specific cross-sectional shape may, for example, be a triangle or a trapezoid. In the cross-sectional shape, a corner or a side (side surface) may be curved.

The top portion of a ridge means a portion that is the highest portion in the cross-sectional shape and that continues in the longitudinal direction of the ridge. The top portion of the ridge may be a plane or a line. For example, when the cross-sectional shape is a trapezoid, the top portion is a plane, and when the cross-sectional shape is a triangle, the top portion is a line. In the present invention, surfaces other than the top portion of a ridge are referred to as side surfaces of ridge. Here, a flat portion between two adjacent ridges is not referred to as a surface of the ridges, but is referred to as a principal surface of the light-transmitting substrate.

The raw material or the material of the light-transmitting substrate may, for example, be a photocurable resin, a thermoplastic resin or a glass, and it is preferably a photocurable resin or a thermoplastic resin from the viewpoint of capability of forming the ridges by an imprint method to be described later, and it is particularly preferably a photocurable resin from the viewpoint of capability of forming the ridges by a photoimprint method and from the viewpoint of excellence in the thermal resistance and durability. The photocurable resin is preferably a photocurable resin obtainable by photocuring of a photocurable composition that is photocurable by photo-radical polymerization, from the viewpoint of productivity. As the photocurable composition constituting the photocurable resin, a known photocurable composition such as the photocurable composition described in paragraphs 0029 to 0074 of the specification of WO2007/116972, may be employed.

The photocurable composition is preferably one which shows a contact angle of at least 90° with water after the composition is photocured to form a cured film. When such a cured film has a contact angle of at least 90° with water, at a time of forming the ridges by a photoimprint method, it is possible to improve a releasing property from a mold, and to achieve a transcription with high accuracy, and to sufficiently exhibit the objective performance of the wire-grid polarizer to be obtained. Further, even if the contact angle is high, there is no problem in adhesion of the cover layer.

### (Cover Layer)

The cover layer covering the ridges is constituted by a metal layer and a metal oxide layer. The metal layer and the metal oxide layer are usually laminated, but like the following embodiments, the metal layer or the metal oxide layer may be present as a single layer or the same type of layers may be laminated on a part of a surface of each ridge.

The cover layer has a strip shape extending in the longitudinal direction of the ridge, which corresponds to a metal wire constituting a wire-grid polarizer.

The cover layer covers at least one side surface of each ridge, and the maximum value of the covering thickness in a region from a half-height position to the bottom portion of the ridge, is smaller than the maximum value of covering thickness in a region from the half-height position to the top portion of the ridge. It is considered that a cover layer covering a region from the half-height position to the top portion of the ridge contributes to improvement of the front surface s-polarized light reflectance, and a cover layer covering a region from the half-height position to the bottom portion of the ridge contributes to lowering of the rear surface s-polarized light reflectance.

The cover layer preferably covers the entire portion of at least one side surface of each ridge in order to lower the rear surface s-polarized light reflectance. The cover layer may cover a part or all of the top portion of each ridge. Further, the cover layer may cover a part of flat portion adjacent to at least one side surface of the ridge.

In order to suppress s-polarized light transmittance and to improve the degree of polarization, the cover layer preferably covers two side surfaces of each ridge, wherein in two side surfaces, the maximum value of the covering thickness in a region from a half-height position to the bottom portion of the ridge, is preferably smaller than the maximum value of the covering thickness in a region from the half-height position to the top portion of the ridge.

A cover layer covering the side surfaces of each ridge is usually continuous. At least one side surface of the ridge is preferably continuously covered by the cover layer, but due to e.g. a problem in production, there is a case where a small portion of side surfaces is not covered by the cover layer. Even in such a case, when at least one side surface is almost continuously covered by the cover layer, it is regarded that at least one side surface is continuously covered by the cover layer.

### (Metal Layer)

A metal layer constituting a part of a cover layer is a layer formed by vapor-depositing aluminum so that no oxide is formed in the metal layer. Here, “so that no oxide is formed in the metal layer” means a condition whereby no oxide is formed in the metal layer at a time of vapor-depositing aluminum by e.g. a vacuum vapor deposition apparatus. It does not mean to suppress formation of thin oxide film on a surface of the metal layer by natural oxidation when the metal layer contacts with air after the wire-grid polarizer is taken out from e.g. the vacuum vapor deposition apparatus.

The metal layer is preferably formed on the front surface side than the metal oxide layer from the viewpoint of increasing the surface s-polarized light reflectance, more preferably formed selectively from the half height position to the top portion of each ridge.

### (Metal Oxide Layer)

A metal oxide layer constituting a part of the cover layer is a layer formed by vapor-depositing aluminum under the presence of oxygen so that oxygen defects are formed in the metal oxide layer.

The metal oxide layer is a layer composed of an aluminum oxide (Al₂O₃₋ₓ, 0<x<3) having oxygen defects, which has a transmittance (T) higher than that of aluminum (Al). Further, the metal oxide layer has a lower transmittance (T) and a higher absorptance (A) than those of a conventional aluminum oxide (Al₂O₃) having no oxygen defect and constituting an absorber layer.

The metal oxide layer is preferably formed on the rear surface side than the metal layer from the viewpoint of lowering a rear surface s-polarized light reflectance, and preferably covers the entire surface of at least one side surface of each ridge.

### <Process for Producing a Wire-Grid Polarizer>

The wire-grid polarizer of the present invention is produced by preparing a light-transmitting substrate having a surface on which a plurality of ridges are formed in parallel with one another at a predetermined pitch, and subsequently forming the cover layer so that the maximum value of the covering thickness in a region from a half-height position to the bottom portion of each ridge, is smaller than the maximum value of the covering thickness in a region from the half-height position to the top portion of the ridge.

### (Preparation of Light-Transmitting Substrate)

The process for producing the light-transmitting substrate may, for example, be an imprinting method (photoimprinting method or thermoimprinting method) or a lithography method. From the viewpoint of productivity in forming the ridges and capability of producing a light-transmitting substrate having a large area, the process is preferably an imprinting method, and from the viewpoint of high productivity in producing the ridges and capability of transferring the shape of grooves of a mold with high precision, the process is particularly preferably a photoimprinting method.

The photoimprinting method is, for example, a method of preparing a mold in which a plurality of grooves are formed in parallel with one another at a predetermined pitch by a combination of electron beam lithography and etching, transferring the shape of the grooves of the mold into a photocurable composition applied on a surface of an optional substratum, and photocuring the photocurable composition at the same time.

The preparation of light-transmitting substrate by the photoimprinting method is preferably specifically carried out through the following steps (i) to (iv). (i) A step of applying a photocurable composition on a surface of a substratum. (ii) A step of pressing a mold in which a plurality of grooves are formed so as to be parallel with one another at a predetermined pitch, against the photocurable composition so that the grooves contact with the photocurable composition. (iii) A step of radiating a radiation (UV rays, electron beams, etc.) to the mold in a state that the mold is pressed against the photocurable composition, to cure the photocurable composition to produce a light-transmitting substrate having a plurality of ridges corresponding to the grooves of the mold. (iv) A step of separating the mold from the light-transmitting substrate. Here, on the obtained light-transmitting substrate on the substratum, it is possible to form the cover layer to be described later while the substrate is integrally combined with the substratum. Further, as the case requires, the light-transmitting substrate and the substratum may be separated after formation of the cover layer. Further, it is possible to form the cover layer to be described later, after the light-transmitting substrate formed on the substratum is separated from the substratum.

The preparation of light-transmitting substrate by a thermoimprinting method is preferably specifically carried out through the following steps (i) to (iii).

(i) A step of forming on a surface of a substratum a layer of thermoplastic resin to which a pattern is to be transferred, or a step of producing a film of thermoplastic resin to which a pattern is to be transcripted.

(ii) A step of pressing a mold in which a plurality of grooves are formed so as to be parallel with one another at a predetermined pitch, against the layer to be transferred or the film to be transferred, so that the grooves contact with the layer to be transferred or the film to be transferred, in a state that they are heated to be at least the glass transition temperature (Tg) or the melting point (Tm) of the thermoplastic resin, to prepare a light-transmitting substrate having a plurality of ridges corresponding to the grooves of the mold. (iii) A step of cooling the light-transmitting substrate to a temperature lower than Tg or Tm and separating the mold from the light-transmitting substrate. Here, on the obtained light-transmitting substrate on the substratum, it is possible to form the cover layer to be described later while the substrate is integrally combined with the substratum. Further, as the case requires, the light-transmitting substrate and the substratum may be separated after formation of the cover layer. Further, it is possible to form the cover layer to be described later, after the light-transmitting substrate formed on the substratum is separated from the substratum.

The material of the mold to be employed for the imprint method may be silicon, nickel, quartz, a resin, etc., and from the viewpoint of transcription accuracy, a resin is preferred. As the resin, a fluororesin (such as an ethylene-tetrafluoroethylene copolymer), a cyclic olefin, a silicone resin, an epoxy resin or an acrylic resin may, for example, be mentioned. From the viewpoint of accuracy of mold, a photocurable acrylic resin is preferred. Such a resin mold preferably has an inorganic film having a thickness of from 2 to 10 nm formed on the surface from the viewpoint of durability against repeated transcription. As the inorganic film, an oxide film such as SiO₂, TiO₂ or Al₂O₃ is preferred.

### (Formation of Cover Layer)

The cover layer is preferably formed by a vapor deposition method. As the vapor deposition method, a physical vapor deposition method (PVD) or a chemical vapor deposition method (CVD) are mentioned, and the vapor deposition method is preferably a vacuum vapor deposition method, a sputtering method or an ion plating method, particularly preferably a vacuum vapor deposition method. In the vacuum vapor deposition method, it is easy to control incident direction of adhering fine particles in relation to the light-transmitting substrate, and it is easy to carry out an oblique vapor deposition method to be described later. In the formation of the cover layer, since it is necessary to selectively vapor-deposit to form the cover layer so that the maximum value of the covering thickness in a region from a half-height position to the bottom portion of each ridge is smaller than the maximum value of the covering thickness in a region from the half-height position to the top portion of the ridge, an oblique vapor deposition method using the vacuum vapor deposition method is the most preferred.

Specifically, the present invention employs a step (1R1) of vapor-depositing aluminum from a direction substantially perpendicular to the longitudinal direction of the ridges and at an angle θ^{R}₁ (°) satisfying the following formula (a) on the first side surface side to the height direction of each ridge to form a metal oxide layer or a metal layer, and after the step (1R1), a step (1R2) of vapor-depositing aluminum from a direction substantially perpendicular to the longitudinal direction of ridges and at an angle θ^{R}₂ (°) satisfying the following formula (b) on the first side surface side to the height direction of each ridge, under a condition so that the vapor-deposition amount becomes larger than that of the step (1R1) to form a metal layer or a metal oxide layer, whereby an objective cover layer is formed. Here, among the step (1R1) and the step (1R2), the metal oxide layer is formed in at least one step and the metal layer is formed in at least one step.

tan(θ^{R}₁±10)=(Pp−Dpb/2)/Hp (a)

θ^{R}₁+3≦θ^{R}₂≦θ^{R}₁+30 (b)

Here, Pp represents the pitch of the ridges, Dpb represents the width of the bottom portion of each ridge, and Hp represents the height of each ridge.

Further, in a case of forming a cover layer covering two side surfaces of each ridge, the present invention employs a step (2R1) of vapor-depositing aluminum from a direction substantially perpendicular to the longitudinal direction of the ridge and at an angle θ^{R}₁ (°) satisfying the following formula (c) on the first side surface side to the height direction of the ridge to form a metal oxide layer or a metal layer; a step (2L1) of vapor-depositing aluminum from a direction substantially perpendicular to the longitudinal direction of the ridge and at an angle θ^{L}₁ (°) satisfying the following formula (d) on the second side surface side to the height direction of the ridge to form a metal oxide layer or a metal layer; and subsequent to the step (2R1), a step (2R2) of vapor-depositing aluminum from a direction substantially perpendicular to the longitudinal direction of the ridge and at an angle θ^{R}₂ (°) satisfying the following formula (e) on the first side surface side to the height direction of the ridge under a condition so that the vapor-deposition amount becomes larger than that of the step (2R1) to form a metal layer or a metal oxide layer; and subsequent to the step (2L1), a step (2L2) of vapor-depositing aluminum from a direction substantially perpendicular to the longitudinal direction of the ridge and at an angle θ^{L}₂ (°) satisfying the following formula (f) on the second side surface side to the height direction of the ridge under a condition so that the vapor-deposition amount becomes larger than that of the step (2L1) to form a metal layer or a metal oxide layer, whereby an objective cover layer is formed. Here, among the step (2R1), the step (2L1), the step (2R2) and the step (2L2), the metal oxide layer is formed in at least one step and the metal layer is formed in at least one step.

tan(θ^{R}₁±10)=(Pp−Dpb/2)/Hp (c)

tan(θ^{L}₁±10)=(Pp−Dpb/2)/Hp (d)

θ^{R}₁+3≦θ^{R}₂≦θ^{R}₁+20 (e)

θ^{L}₁+1≦θ^{L}₂≦θ^{L}₁+20 (f)

Here, Pp represent the pitch of the ridges, Dpb represents the width of the bottom portion of each ridge, and Hp represents the height of each ridge.

### (Formation of Metal Layer)

In the process for producing a wire-grid polarizer of the present invention, a metal layer constituting a part of a cover layer is formed by vapor-depositing aluminum on the ridges, the metal oxide layer or another metal layer so that no aluminum oxide is formed in the metal layer. Here, “so that no oxide is formed in the metal layer” means a condition whereby no oxide is formed in the metal layer at a time of vapor-depositing aluminum by e.g. a vacuum vapor deposition apparatus. It does not mean to suppress formation of a thin oxide film on a surface of the metal layer by natural oxidation caused when the metal layer contacts with the air after the wire-grid polarizer is taken out from e.g. the vacuum vapor deposition apparatus.

In the process for producing a wire-grid polarizer of the present invention, it is preferred to form a metal layer under a vapor deposition condition whereby when aluminum is deposited on a flat portion with a vapor deposition amount of 20 nm, a thin film of aluminum having a transmittance T (%) of less than 3% and a reflectance R (%) of more than 85%, is formed.

Specifically, without introducing oxygen into a vacuum vapor deposition apparatus, aluminum is quickly vapor-deposited with relatively high vapor deposition speed (preferably at least 1.3 nm/sec, more preferably at least 1.5 nm/sec, still more preferably at least 1.8 nm/sec. Further, from the viewpoint of controlling film thickness of high accuracy, the vapor deposition speed is preferably at most 20 nm/sec) to form a metal layer.

### (Formation of Metal Oxide Layer)

In the process for producing a wire-grid polarizer of the present invention, aluminum is vapor-deposited on each ridge, the metal layer or another metal oxide layer under the presence of oxygen so that oxygen defects are formed in a metal oxide layer to form the metal oxide layer constituting a part of the cover layer.

In the process for producing a wire-grid polarizer of the present invention, it is preferred to form a metal oxide layer under a vapor-deposition condition whereby when aluminum is vapor-deposited on a flat portion with a vapor deposition amount of 20 nm, a thin film of aluminum oxide having a transmittance T (%) and a reflectance R (%) satisfying the following formulae (j) to (m) is formed.

3≦T≦90 (j)

5≦R≦90 (k)

50≦T+R≦97 (l)

90≦T+2R (m)

At least 3% of transmittance (T) indicates that, for example, as shown in FIG. 13 in the Example to be described later, not aluminum (Al) but an aluminum oxide (Al₂O₃₋ₓ) having oxygen defects or an aluminum oxide (Al₂O₃) having no oxygen defect is formed.

Further, at most 90% of transmittance (T) and at most 97% of the total of transmittance (T) and reflectance (R) (that is at least 3% of absorptance (A)) indicate that, for example, as shown in FIG. 13 in the Example to be described later, not an aluminum (Al₂O₃) having no oxygen defect, but an aluminum oxide (Al₂O₃₋ₓ) having oxygen defects is formed.

Here, an aluminum oxide having a transmittance (T) and a reflectance (R) satisfying that T+2R is smaller than 90% (that is, a region bellow a broken line representing A=R+10 in FIG. 13 is satisfied) is excluded in the present invention since it was extremely difficult to form such an aluminum oxide in the experiment of the present inventors.

Thus, under the vapor deposition condition whereby a thin film of metal oxide satisfying the formulae (j) to (m) is formed, a practical metal oxide layer composed of an aluminum oxide (Al₂O₃₋ₓ) having oxygen defects is formed.

Specifically, when no oxygen is introduced into the vacuum vapor deposition apparatus, aluminum is slowly vapor-deposited with a relatively low vapor deposition speed (preferably at most 1.2 nm/sec, more preferably at most 1.1 nm/sec, still more preferably at most 1.0 nm/sec, and from the viewpoint of carrying out deposition within a predetermined time, preferably at least 0.05 nm/sec) to form a metal oxide layer. Further, when oxygen is introduced into the vacuum vapor deposition apparatus, aluminum is vapor-deposited with a proper oxygen introduction amount (preferably from 1 to 50 sccm, more preferably from 5 to 40 sccm) and a proper vapor deposition speed (preferably from 0.1 to 3.0 nm/sec, more preferably from 0.3 to 2.0 nm/sec) to form a metal oxide layer. Here, if the vapor deposition speed is too slow or the oxygen introduction amount is too large, an aluminum oxide (Al₂O₃) having no oxygen defect may be formed.

The transmittance (T) is more preferably at most 80%, still more preferably at most 75%.

The reflectance (R) is more preferably at least 10%, still more preferably at least 15%.

The total of transmittance (T) and reflectance (R) is more preferably at most 95%, still more preferably at most 90%. Further, it is more preferably at least 55%, still more preferably at least 60%.

### (Condition Setting of Vapor Deposition Conditions)

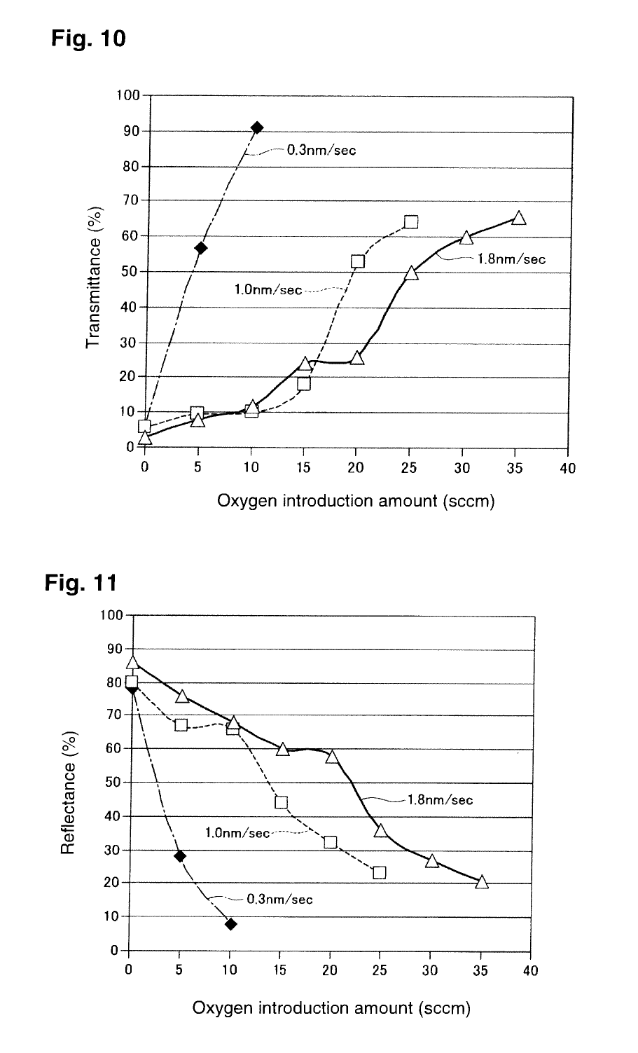

The vapor deposition conditions whereby a thin film of metal oxide satisfying formulae (j) to (m) can be appropriately determined by a person skilled in the art by changing the vapor deposition speed and the oxygen introduction amount, vapor-depositing aluminum on a flat portion with a vapor deposition amount of 20 nm to repeatedly form a thin film composed of an aluminum oxide, measuring the transmittance (T) and the reflectance (R) and plotting them in a graph as shown in FIGS. 10 to 13 shown in the Examples to be described later.

Specifically, the condition setting of the vapor deposition conditions may be carried out in the following procedure.

(i) In a vacuum vapor deposition apparatus, a vapor deposition source (aluminum) is heated under predetermined heating conditions to vapor-deposit aluminum on a flat substrate (such as glass substrate) in a predetermined vapor deposition time to form a thin film.

(ii) The thickness of the thin film is measured, and it is divided by the vapor deposition time to calculate the vapor deposition speed.

(iii) In the vacuum vapor deposition apparatus, the vapor deposition source (aluminum) is heated under the same heating conditions as those of procedure (i) to vapor deposit aluminum on a flat substrate (such as a glass substrate) in a vapor deposition time whereby the vapor deposition amount becomes 20 nm, to form a thin film.

(iv) The transmittance (T) and the reflectance (R) of the thin film is measured by an UV-visible spectrophotometer.

(v) While changing oxygen introduction amount, the procedures (iii) and (iv) are repeatedly carried out.

(vi) While changing heating conditions of the vapor deposition source (aluminum), procedures (i) to (v) are repeatedly carried out.

Further, in a case of employing the vapor deposition apparatus described in JP-A-2008-038198 and continuously carrying out a vapor deposition on a light-transmitting substrate rolled out from a roll, the transmittance (T) and the reflectance (R) of a thin film vapor-deposited on a flat portion of the light-transmitting substrate with a vapor deposition amount of 20 nm may be measured by a transmittance sensor and a reflectance sensor provided in the vapor deposition apparatus while changing the heating conditions of the vapor deposition source (aluminum) or the oxygen introduction amount.

### <Wire-Grid Polarizer of Each Embodiment>

Embodiments of wire-grid polarizers produced by the process of the present invention are described below with reference to drawings. The drawings are schematic views, and an actual wire-grid polarizer does not have the logical and ideal shape as shown in these drawings. For example, there is a considerable degree of deformation in the shape of e.g. each ridge and there is also a considerable amount of unevenness of the thickness of the cover layer. Here, dimensions of the ridge and the cover layer of the present invention are each obtained by measuring the dimension of the ridge or the dimension of cover layer on the ridge with respect to five ridges in a transmission electron microscopic image of a cross-section of the wire-grid polarizer, and averaging the five dimensions.

### First Embodiment

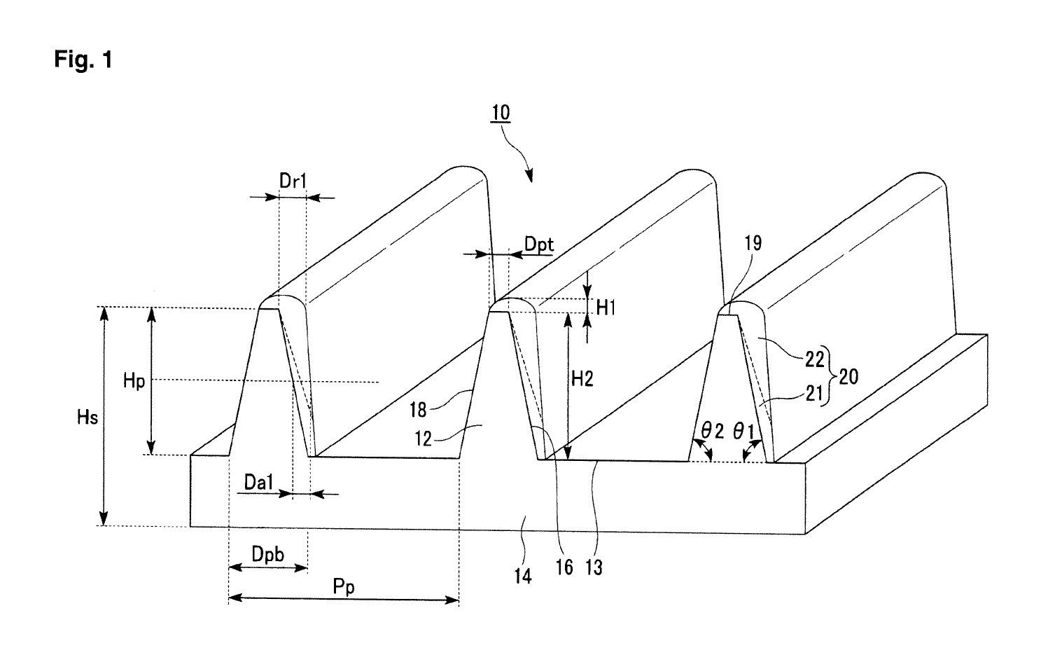

FIG. 1 is a perspective view showing a first embodiment of the wire-grid polarizer produced by the process of the present invention. A wire-grid polarizer 10 has a light-transmitting substrate 14 having a surface on which a plurality of ridges 12 each having a trapezoidal cross-section are formed in parallel with one another at a predetermined pitch Pp with flat portions 13 of grooves formed between the ridges 12; a metal oxide layer 21 covering the entire surface of a first side surface 16 of each ridge 12; and a metal layer 22 formed on a surface of the metal oxide layer 21 from the half-height position to the top portion 19 and on the top portion 19 of each ridge.

The cover layer is constituted by a first cover layer 20.

The first cover layer 20 is constituted by the metal oxide layer 21 and the metal layer 22, and the maximum value of the covering thickness from the half height position to the bottom portion of each ridge 12 is smaller than the maximum value of the covering thickness from the half height position to the top portion 19 of the ridge 12.

The cover layer extends in the longitudinal direction of the ridge 12 to constitute a fine metal wire.

### (Light-Transmitting Substrate)

Pp is a sum total of the width Dpb of the bottom portion of each ridge 12 and the width of each flat portion 13 formed between the ridges 12. Pp is preferably at most 300 nm, more preferably from 50 to 250 nm. When Pp is at most 300 nm, the wire-grid polarizer shows a high front surface s-polarized light reflectance and shows a high degree of polarization in a short wavelength region of about 400 nm. Further, coloring due to refraction can be suppressed. Further, when Pp is from 50 to 200 nm, it is easy to form each layer by vapor deposition.

The ratio (Dpb/Pp) between Dpb and Pp is preferably from 0.1 to 0.7, more preferably from 0.25 to 0.55. When Dpb/Pp is at least 0.1, the wire-grid polarizer shows a high degree of polarization. When Dpb/Pp is at most 0.7, coloring of transmission light due to interference can be suppressed. Dpb is preferably from 30 to 100 nm from the viewpoint of easiness of formation of each layer by vapor deposition.

The width Dpt of a top portion 19 of each ridge 12 is preferably at most a half of Dpb, more preferably at most 40 nm, still more preferably at most 20 nm. When Dpt is at most a half of Dpb, the p-polarized light transmittance becomes further higher and its angle dependence becomes sufficiently low.

The height Hp of the ridge 12 is preferably from 120 to 300 nm, more preferably from 80 to 270 nm. When Hp is at least 120 nm, polarized light separation ability becomes sufficiently high. When Hp is at most 300 nm, wavelength dispersion becomes small. Further, when Hp is from 80 to 270 nm, it is easy to form the first metal layer 20 by vapor deposition.

A slope angle θ₁ of the first side surface 16 and a slope angle θ₂ of the second side surface 18 are preferably 30 to 80°. θ₁ and θ₂ may be the same or different. More preferably, each of θ₁ and θ₂ is from 45 to 80°. The thickness Hs of the light-transmitting substrate 14 is preferably from 0.5 to 1,000 μm, more preferably from 1 to 40 μm.

### (First Cover Layer)

The maximum value Dr1 of the covering thickness (thickness in the width direction of ridge) of the first metal layer 20 covering a region from a half-height position to the top portion 19 of each ridge 12 (upper half of ridge 12) is preferably at most 80 nm. It is preferably from 20 to 75 nm, more preferably from 35 to 55 nm, particularly preferably from 40 to 50 nm. When Dr1 is at least 20 nm, the front surface s-polarized light reflectance becomes sufficiently high. When Dr1 is at most 80 nm, the p-polarized light transmittance becomes sufficiently high.

The maximum value Da1 of the covering thickness (thickness in the width direction of ridge) of the first cover layer 20 covering a region from a half-height position to the bottom portion of the ridge 12 (lower half of ridge), is preferably from 4 to 25 nm, more preferably from 5 to 22 nm. When Da1 is at least 4 nm, the rear surface s-polarized light reflectance becomes sufficiently low. When Da1 is at most 25 nm, the p-polarized light transmittance becomes sufficiently high.

The maximum value Dr1 of the covering thickness covering a region from the half-height position to the top portion 19 of the ridge 12 (upper half of ridge) preferably satisfies the following formula (I).

0.2×(Pp−Dpb)≦Dr1≦0.95×(Pp−Dpb) (i)

When Dr1 is at least 0.2×(Pp−Dpb), s-polarized light transmittance becomes low, polarized light separation ability becomes sufficiently high and its wavelength dispersion is small. When Dr1 is at most 0.95×(Pp−Dpb), the wire-grid polarizer shows a high p-polarized light transmittance.

The ratio (Dr1/Da1) of the maximum value Dr1 of the covering thickness covering a region from the half-height position to the top portion of the ridge 12 (upper half of the ridge) based on the maximum value Da1 of the covering thickness covering from the half-height position to the bottom portion of the ridge 12 (lower half of the ridge), is preferably from 2.5 to 10, more preferably from 3 to 8. When Dr1/Da1 is at least 2.5, polarized light separation ability becomes sufficiently high and its wavelength dispersion is small. When Dr1/Da1 is at most 10, the wire-grid polarizer shows a high p-polarized light transmittance.

With respect to the height H2 of a first metal layer 20 present below (light-transmitting substrate side) the top portion 19 of the ridge 12, H2/Hp is preferably from 0.8 to 1, more preferably from 0.9 to 1. When H2/Hp is at most 1, polarized light separation ability becomes high. When H2/Hp is at least 0.8, rear surface s-polarized light reflectance becomes sufficiently low.

With respect to the height H1 of the first metal layer 20 present above (far side from the light-transmitting substrate 14) the top portion 19 of the ridge 12, H1/Hp is preferably from 0.05 to 0.7, more preferably from 0.1 to 0.5. When H1/Hp is at most 0.7, rear surface s-polarized light reflectance becomes sufficiently low. When H1/Hp is at least 0.05, front surface s-polarized light reflectance becomes sufficiently high.

### Second Embodiment

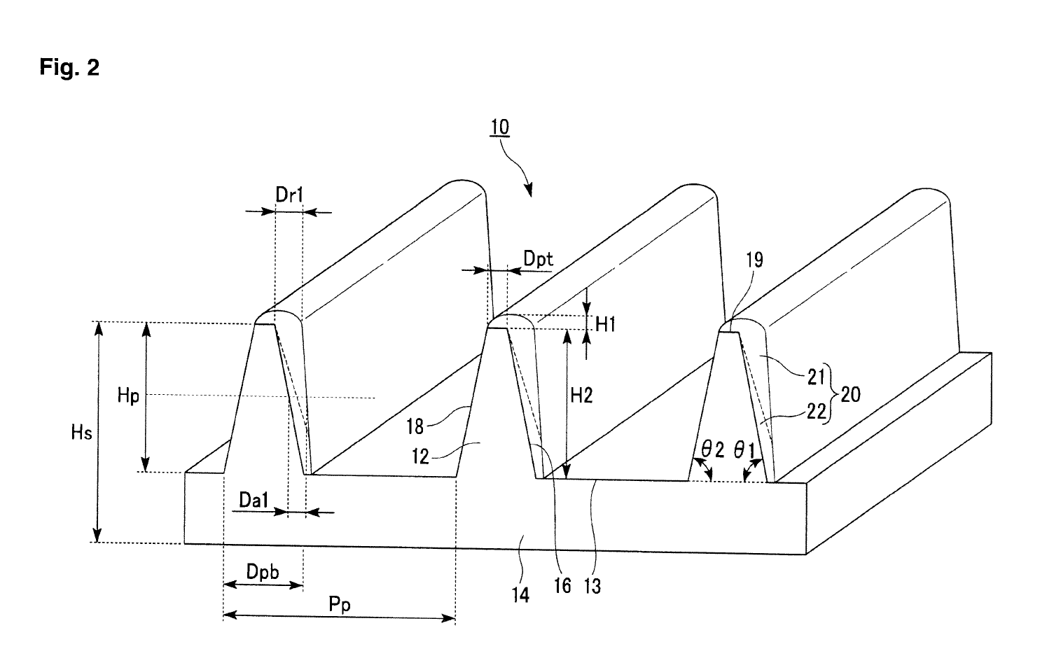

FIG. 2 is a perspective view showing a second embodiment of the wire-grid polarizer produced by the process of the present invention. A wire-grid polarizer 10 has a light-transmitting substrate 14 having a surface on which a plurality of ridges 12 each having a trapezoidal cross-section are formed in parallel with one another at a predetermined pitch Pp with flat portions 13 of grooves formed between the ridges 12; a metal layer 22 covering the entire surface of a first side surface 16 of each ridge 12, and a metal oxide layer 21 formed on a surface of the metal oxide layer 21 from the half-height position to the top portion 19 and on the top portion 19 of each ridge.

The cover layer is constituted by a first cover layer 20.

The first cover layer 20 is constituted by a metal layer 22 and a metal oxide layer 21, and the maximum value of the covering thickness from the half height position to the bottom portion of each ridge 12 is smaller than the maximum value of the covering thickness from the half height position to the top portion 19 of the ridge 12.

The cover layer extends in the longitudinal direction of the ridge 12 to constitute a fine metal wire.

In the second embodiment, explanations of constructions common to the wire-grid polarizer 10 of the first embodiment are omitted.

### Third Embodiment

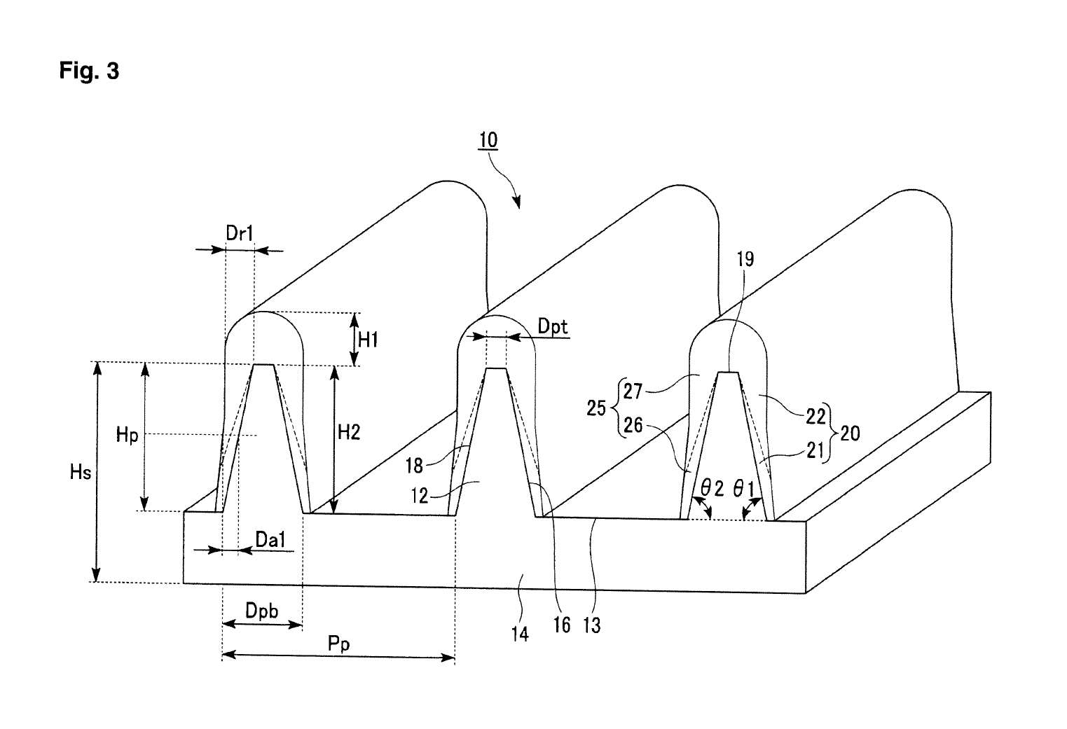

FIG. 3 is a perspective view showing a third embodiment of the wire-grid polarizer produced by the process of the present invention. A wire-grid polarizer 10 has a light-transmitting substrate 14 having a surface on which a plurality of ridges 12 each having a trapezoidal cross-section are formed in parallel with one another at a predetermined pitch Pp with flat portions 13 of grooves formed between the ridges 12; a metal oxide layer 21 covering the entire surface of a first side surface 16 of each ridge 12, and a metal layer 22 formed on a surface of the metal oxide layer 21 from the half-height position to the top portion 19 and on the top portion 19 of each ridge; a metal oxide layer 26 covering the entire surface of a second side surface 18 of each ridge 12; and a metal layer 27 formed on a surface of the metal oxide layer 26 from the half-height position to the top portion 19 and on the top portion 19 of each ridge.

The cover layer is constituted by a first cover layer 20 and a second cover layer 25.

The first cover layer 20 is constituted by the metal oxide layer 21 and the metal layer 22, and the maximum value of the covering thickness from the half height position to the bottom portion of each ridge 12 is smaller than the maximum value of the covering thickness from the half height position to the top portion 19 of the ridge 12.

The second cover layer 25 is constituted by the metal oxide layer 26 and the metal layer 27, and the maximum value of the covering thickness from the half height position to the each ridge 12 is smaller than the maximum value of the covering thickness from the half height position to the top portion 19 of the ridge 12.

The cover layer extends in the longitudinal direction of the ridge 12 to constitute a fine metal wire.

In the third embodiment, the rear surface s-polarized light reflectance is lower than those of the first and second embodiments. In the third embodiment, explanations of the constructions common to the wire-grid polarizers 10 of the first and second embodiments are omitted.

### (First Cover Layer)

The maximum value Dr1 of the covering thickness of the first cover layer 20 (thickness in the width direction of the ridge) covering a region of from a half-height position to the top portion 19 of each ridge 12 (upper half of ridge 12), is preferably at most 50 nm. It is preferably from 10 to 45 nm, more preferably from 15 to 35 nm. When Dr1 is at least 10 nm, the front surface s-polarized light reflectance becomes sufficiently high. When Dr1 is at most 50 nm, the p-polarized light transmittance becomes sufficiently high.

A preferred embodiment of the maximum value Da1 of the covering thickness of the first cover layer 20 (thickness in the width direction of the ridge) covering a region from the half-height position to the bottom portion of the ridge 12 (lower half of the ridge), is similar to that of the first embodiment.

The ratio (Dr1/Da1) of the maximum value Dr1 of the covering thickness in a region from the half-height position to the top portion 19 of the ridge 12 (upper half of the ridge) based on the maximum value Da1 of the covering thickness in a region from the half-height position to the bottom portion of the ridge 12 (lower half of the ridge), is preferably from 1.5 to 6, more preferably from 2 to 4. When Dr1/Da1 is at least 1.5, polarized light separation ability becomes sufficiently high and its wavelength dispersion is small. When Dr1/Da1 is at most 6, the wire-grid polarizer shows a high p-polarized light transmittance.

With respect to the height H2 of the first cover layer 20 present below the top portion of the ridge 12, H2/Hp is preferably from 0.8 to 1, more preferably from 0.9 to 1. When H2/Hp is at most 1, polarized light separation ability becomes high. When H2/Hp is at least 0.8, rear surface s-polarized light reflectance becomes sufficiently low.

A preferred embodiment of the second metal layer 25 is similar to the preferred embodiment of the first metal layer 20.

Above the top portion of the ridge 12, the first cover layer 20 and the second cover layer 25 overlap with each other. With respect to the height H1 of the first metal layer 20 present above the top portion 19 of the ridge 12, H1/Hp is preferably from 0.05 to 0.7, more preferably from 0.1 to 0.5. When H1/Hp is at most 0.7, rear surface s-polarized light reflectance becomes sufficiently low. When H1/Hp is at least 0.05, front surface s-polarized light reflectance becomes sufficiently high.

### Fourth Embodiment

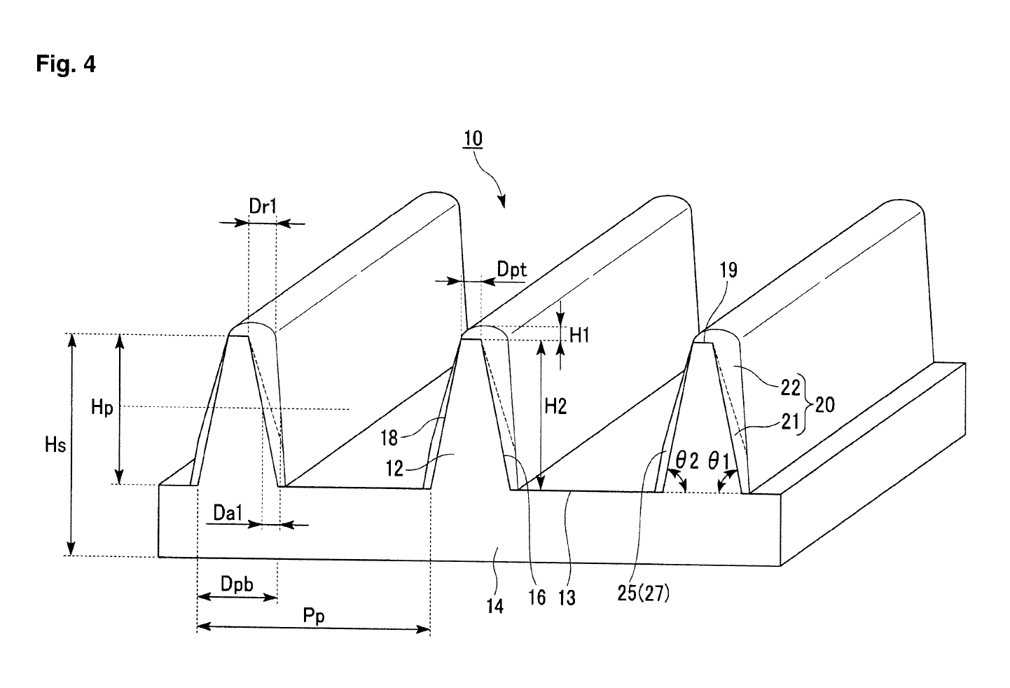

FIG. 4 is a perspective view showing a fourth embodiment of the wire-grid polarizer produced by the process of the present invention. A wire-grid polarizer 10 has a light-transmitting substrate 14 having a surface on which a plurality of ridges 12 each having a trapezoidal cross-section are formed in parallel with one another at a predetermined pitch Pp with flat portions 13 of grooves formed between the ridges 12; a metal oxide layer 21 covering the entire surface of a first side surface 16 of each ridge 12; a metal layer 22 formed on a surface of the metal oxide layer 21 from the half-height position to the top portion 19 and on the top portion 19 of each ridge; and a metal layer 27 covering the entire surface of the second side surface 18 of the ridge 12.

The cover layer is constituted by a first cover layer 20 and a second cover layer 25.

The first cover layer 20 is constituted by the metal oxide layer 21 and the metal layer 22, and the maximum value of the covering thickness from the half height position to the bottom portion of each ridge 12 is smaller than the maximum value of the covering thickness from the half height position to the top portion 19 of the ridge 12.

The second cover layer 25 is constituted by the metal layer 27 alone.

The cover layer extends in the longitudinal direction of the ridge 12 to constitute a fine metal wire.

In the fourth embodiment, the rear surface s-polarized light reflectance is lower than those of the first and second embodiments.

In the fourth embodiment, explanations of the constructions common to the wire-grid polarizers 10 of the first and the third embodiments are omitted.

### (Second Cover Layer)

The maximum value Da2 of the thickness of the second cover layer 25 in the width direction of each ridge 12 is preferably from 4 to 25 nm, more preferably from 5 to 22 nm, When Da2 is at least 4 nm, the rear surface s-polarized light reflectance becomes sufficiently low. When Da2 is at most 25 nm, the p-polarized light transmittance becomes sufficiently high.

With respect to the height H3 (not shown in FIG. 4) of the second cover layer 25 present below the top portion 19 of the ridge 12, H3/Hp is preferably from 0.8 to 1, more preferably from 0.9 to 1. When H3/Hp is at most 1, the polarized light separation ability becomes high. When H3/Hp is at least 0.8, the rear surface s-polarized light reflectance becomes sufficiently low.

### Fifth Embodiment

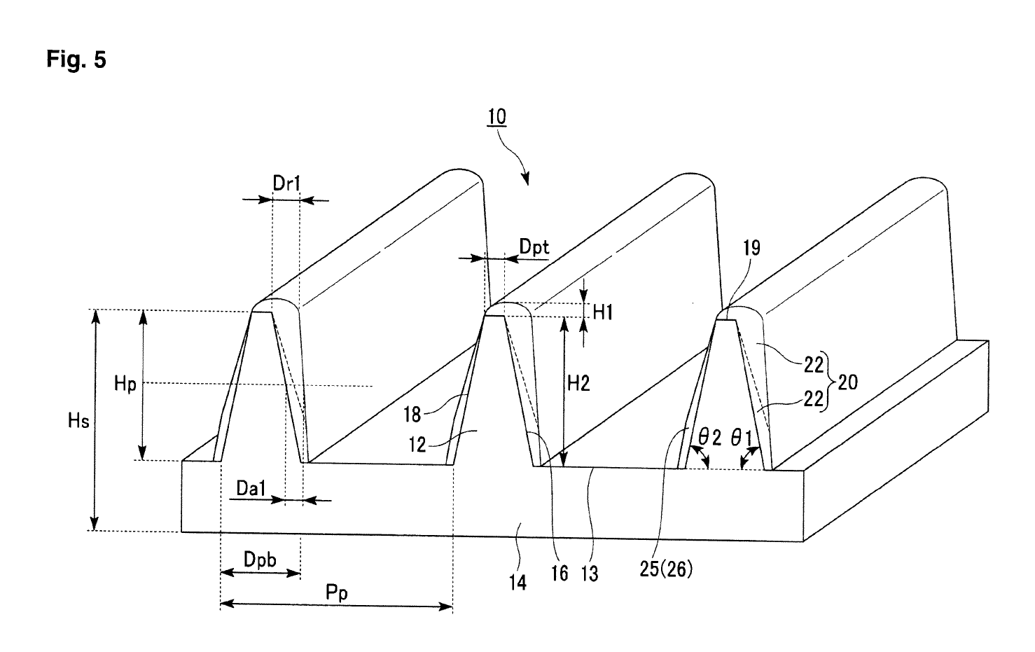

FIG. 5 is a perspective view showing a fifth embodiment of the wire-grid polarizer produced by the process of the present invention. A wire-grid polarizer 10 has a light-transmitting substrate 14 having a surface on which a plurality of ridges 12 each having a trapezoidal cross-section are formed in parallel with one another at a predetermined pitch Pp with flat portions 13 of grooves formed between the ridges 12; a metal layer 22 covering the entire surface of a first side surface 16 of each ridge 12; a metal layer 22 formed on a surface of the metal layer 22 from the half-height position to the top portion 19 and on the top portion 19 of each ridge; and a metal oxide layer 26 covering the entire surface of the second side surface 18 of the ridge 12.

The cover layer is constituted by a first cover layer 20 and a second cover layer 25.

The first cover layer 20 is constituted by two metal layers 22, and the maximum value of the covering thickness from the half height position to the bottom portion of each ridge 12 is smaller than the maximum value of the covering thickness from the half height position to the top portion 19 of the ridge 12.

The second cover layer 25 is constituted by the metal oxide layer 26 alone.

The cover layer extends in the longitudinal direction of the ridge 12 to constitute a fine metal wire.

In the fifth embodiment, the rear surface s-polarized light reflectance is lower than those of the first and second embodiments.

In the fifth embodiment, explanations of the constructions common to the wire-grid polarizers 10 of the first and the third embodiments are omitted.

### Sixth Embodiment

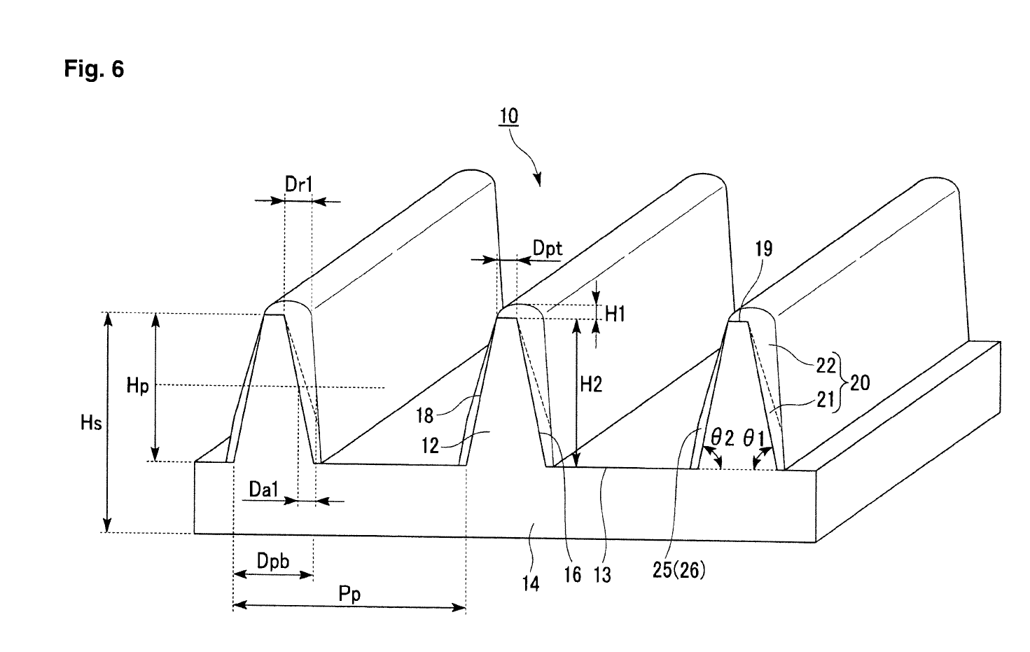

FIG. 6 is a perspective view showing a sixth embodiment of the wire-grid polarizer produced by the process of the present invention. A wire-grid polarizer 10 has a light-transmitting substrate 14 having a surface on which a plurality of ridges 12 each having a trapezoidal cross-section are formed in parallel with one another at a predetermined pitch Pp with flat portions 13 of grooves formed between the ridges 12; a metal oxide layer 21 covering the entire surface of a first side surface 16 of each ridge 12; a metal layer 22 formed on a surface of the metal oxide layer 21 from the half-height position to the top portion 19 and on the top portion 19 of each ridge; and a metal oxide layer 26 covering the entire surface of the second side surface 18 of the ridge 12.

The cover layer is constituted by a first cover layer 20 and a second cover layer 25.

The first cover layer 20 is constituted by the metal oxide layer 21 and the metal layer 22, and the maximum value of the covering thickness from the half height position to the bottom portion of each ridge 12 is smaller than the maximum value of the covering thickness from the half height position to the top portion 19 of the ridge 12.

The second cover layer 25 is constituted by the metal oxide layer 26 alone.

The cover layer extends in the longitudinal direction of the ridge 12 to constitute a fine metal wire.

In the sixth embodiment, the rear surface s-polarized light reflectance is lower than those of the first and second embodiments.

In the sixth embodiment, explanations of the constructions common to the wire-grid polarizers 10 of the first and the fourth embodiments are omitted.

### <Process for Producing Wire-Grid Polarizer of Each Embodiment>

### [Process for Producing Wire-Grid Polarizer of First Embodiment]

The wire-grid polarizer 10 of the first embodiment can be produced by carrying out a step (1R1) of forming a metal oxide layer 21 on a first side surface 16 of each ridge 12 of a light-transmitting substrate 14, and after the step (1R1), a step (1R2) of forming a metal layer 22 on a surface of the metal oxide layer 21.

### (Formation of Metal Oxide Layer)

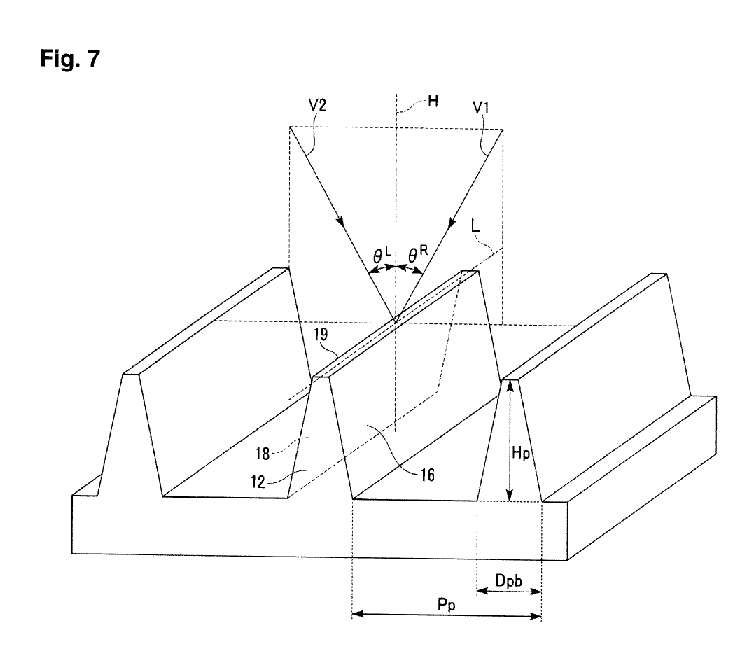

The metal oxide layer 21 can be formed, as shown in FIG. 7, by carrying out a step (1R1) of vapor-depositing aluminum from a direction V1 substantially perpendicular to the longitudinal direction of each ridge 12 and at an angle θ^{R}₁ (°) satisfying the following formula (a) on the first side surface 16 side to the height direction H of the ridge 12.

tan(θ^{R}₁±10)=(Pp−Dpb/2)/Hp (a)

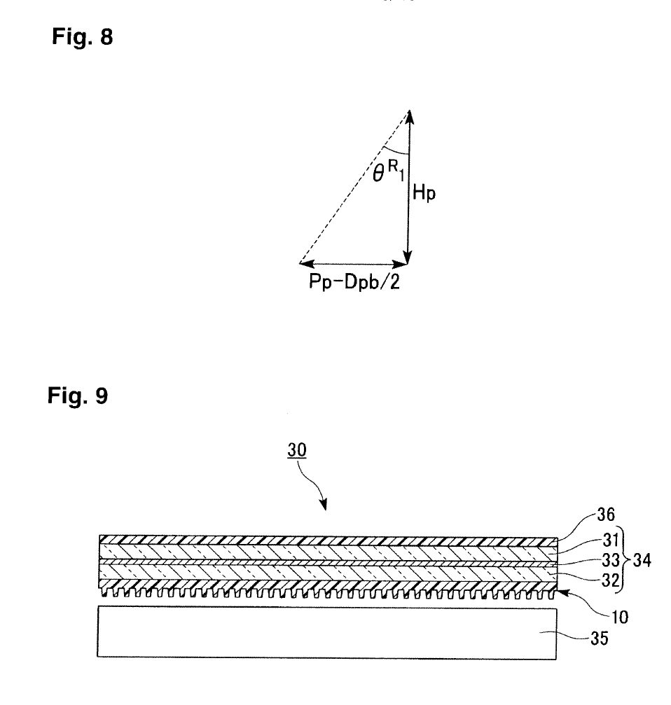

The angle θ^{R}₁ (°) of formula (a) represents an angle at which aluminum is vapor-deposited up to a bottom side of a surface of each ridge 12 without being blocked by an adjacent ridge 12, and as shown in FIG. 8, it is determined by the distance (Pp−Dpb/2) from the surface of the bottom portion of the ridge 12 to the center of the bottom portion of the adjacent ridge 12, and the height Hp of the top portion of the adjacent ridge 12. “±10” represents amplitude tolerable range.

The angle θ^{R}₁ (°) preferably satisfies an equation tan(θ^{R}₁±7)=(Pp−Dpb/2)/Hp, more preferably satisfies an equation tan(θ^{R}₁±5)=(Pp−Dpb/2)/Hp.

The vapor deposition is preferably carried out under a condition so that the vapor deposition amount becomes 4 to 25 nm, more preferably carried out under a condition so that the vapor deposition amount becomes 5 to 22 nm. The vapor deposition may be carried out while continuously changing the angle θ^{R}₁ (°) within a range satisfying the formula (a) under a condition so that the total vapor deposition amount becomes 4 to 25 nm. In a case of continuously changing the angle θ^{R}₁ (°), it is preferred to change the angle towards a direction to reduce the angle. The condition so that the vapor deposition amount becomes 4 to 25 nm, means a condition so that the thickness t of a cover layer formed by vapor-depositing aluminum on a surface of a flat portion where no ridge is formed, becomes 4 to 25 nm, at a time of forming the cover layer on each ridge.

The metal oxide layer 21 is formed by vapor-depositing aluminum under the presence of oxygen so that oxygen defects are formed in the metal oxide layer 21.

Specifically, the metal oxide layer 21 is preferably formed under vapor deposition conditions whereby when aluminum is vapor deposited on a flat portion with a vapor deposition amount of 20 nm, a thin film of aluminum oxide having a transmittance T (%) and a reflectance R (%) satisfying the above formulae (j) to (m) is formed.

### (Formation of Metal Layer)

The metal layer 22 can be formed by carrying out, after the step (1R1), as shown in FIG. 7, a step (1R2) of vapor-depositing aluminum from a direction of V1 substantially perpendicular to the longitudinal direction L of each ridge 12 and at an angle θ^{R}₂ (°) satisfying the following formula (b) on the first side surface 16 side to the height direction H of the ridge 12 under a condition so that the vapor deposition amount becomes larger than that of the step (1R1).

θ^{R}₁+3≦θR₂≦θ^{R}₁+30 (b)

The angle θ^{R}₂ (°) preferably satisfies an inequation θ^{R}₁+6≦θ^{R}₂≦θ^{R}₁+25, more preferably satisfies an inequation θ^{R}₁+10≦θ^{R}₂≦θ^{R}₁+20.

The vapor deposition is preferably carried out under a condition so that the vapor deposition amount becomes larger than that of the step (1R1) and the vapor deposition amount becomes 25 to 70 nm, more preferably carried out under a condition so that the vapor deposition amount becomes 30 to 60 nm. It is also possible to carry out vapor deposition while continuously changing the angle θ^{R}₂ (°) within a range satisfying the formula (b) under a condition so that the total vapor deposition amount becomes 25 to 70 nm. In the case of continuously changing the angle θ^{R}₂ (°), it is preferred to change the angle in a direction of reducing the angle.

The metal layer 22 is formed by vapor-depositing aluminum so that no aluminum oxide is formed in the metal layer 22. Specifically, the metal layer is preferably formed under the vapor deposition conditions whereby when aluminum is vapor-deposited on a flat portion with a vapor deposition amount of 20 nm, a thin film of aluminum having a transmittance T (%) of less than 3% and a reflectance R (%) of more than 85% is formed.

### [Process for Producing a Wire-Grid Polarizer of Second Embodiment]

The wire-grid polarizer 10 of the second embodiment can be produced in the same manner as the process of the first embodiment except that the metal oxide layer 22 formed in step (1R1) is changed to a metal layer 22 and that the metal layer 22 formed in the step (1R2) is changed to a metal oxide layer 21.

### [Process for Producing a Wire-Grid Polarizer of Third Embodiment]

A wire-grid polarizer 10 of the third embodiment can be produced by carrying out a step (2R1) of forming a metal oxide layer 21 on a first side surface 16 of each ridge 12 of the light-transmitting substrate 14; a step (2L1) of forming a metal oxide layer 26 on a second side surface 18 of the ridge 12 of the light-transmitting substrate 14; after the step (2R1), a step (2R2) of forming a metal layer 22 on a surface of the metal oxide layer 21; and after the step (2L1), a step (2L2) of forming a metal layer 27 on a surface of the metal oxide layer 26. The order of these steps is preferably the step (2R1), the step (2L1), the step (2R2) and the step (2L2), but it may be the step (2R1), the step (2R2), the step (2L1) and the step (2L2), or it may be a step (2R1), the step (2L1), the step (2L2) and the step (2R2). In the process of the third embodiment, explanations of the same subject matter as that of the wire-grid polarizer 10 of the first embodiment are omitted.

### (Formation of Metal Oxide Layer of First Cover Layer Side)

A metal oxide layer 21 can be formed, as shown in FIG. 7, by carrying out a step (2R1) of vapor-depositing aluminum from a direction V1 substantially perpendicular to the longitudinal direction L of each ridge 12 and at an angle θ^{R}₁ (°) satisfying the following formula (c) on the first side surface 16 side to the height direction H of the ridge 12.

tan(θ^{R}₁±10)=(Pp−Dpb/2)/Hp (c)

The angle θ^{R}₁ (°) preferably satisfies an equation tan(θ^{R}₁±7)=(Pp−Dpb/2)/Hp, more preferably satisfies an equation tan(θ^{R}₁±5)=(Pp−Dpb/2)/Hp.

The vapor deposition is preferably carried out under a condition so that the vapor deposition amount becomes 4 to 25 nm, more preferably carried out under a condition so that the vapor deposition amount becomes 5 to 22 nm. It is possible to carry out the vapor deposition while continuously changing the angle θ^{R}₁ (°) within a range satisfying the formula (c) under a condition so that the total vapor deposition amount becomes 4 to 25 nm. In the case of continuously changing the angle θ^{R}₁ (°), it is preferred to change the angle in a direction of reducing the angle. (Formation of metal oxide layer of second cover layer side)

A metal oxide layer 26 can be formed, as shown in FIG. 7, by carrying out a step (2L1) of vapor-depositing aluminum from a direction V2 substantially perpendicular to the longitudinal direction L of each ridge 12 and at an angle θ^{L}₁ (°) satisfying the following formula (d) on the second side surface 18 side to the height direction H of the ridge 12.

tan(θ^{L}₁±10)=(Pp−Dpb/2)/Hp (d)

The angle θ^{L}₁ (°) preferably satisfies an equation tan(θ^{L}₁9±7)=(Pp−Dpb/2)/Hp, more preferably satisfies an equation tan(θ^{L}₁±5)=(Pp−Dpb/2)/Hp.

The vapor deposition is preferably carried out under a condition so that the vapor deposition amount becomes 4 to 25 nm, more preferably carried out under a condition so that the vapor deposition amount becomes 5 to 22 nm. It is possible to carry out the vapor deposition while continuously changing the angle θ^{L}₁ (°) within a range satisfying the formula (d) under a condition so that the total vapor deposition amount becomes 4 to 25 nm. In the case of carrying out the step (2L1) after the step (2R1) and continuously changing the angle θ^{L}₁ (°), it is preferred to change the angle in a direction of increasing the angle.

The metal oxide layer 26 is formed by vapor-depositing aluminum under the presence of oxygen so that oxygen defects are formed in the metal oxide layer 26. Specifically, the metal oxide layer is preferably formed under vapor deposition conditions whereby when aluminum is vapor deposited on a flat portion with a vapor deposition amount of 20 nm, a thin film of aluminum oxide having a transmittance T (%) and a reflectance R (%) satisfying the above formulae (j) to (m) is formed.

### (Formation of Metal Layer of First Cover Layer Side)

A metal layer 22 can be formed, as shown in FIG. 7, by carrying out, after the step (2R1), a step (2R2) of vapor-depositing aluminum from a direction V1 substantially perpendicular to the longitudinal direction L of each ridge 12 and at an angle θ^{R}₂ (°) satisfying the following formula (e) on the first side surface 16 side to the height direction H of the ridge 12 under a condition so that the vapor deposition amount becomes larger than that of the step (2R1).

θ^{R}₁+3≦θ^{R}₂≦θ^{R}₁+20 (e)

The angle θ^{R}₂ (°) preferably satisfies an inequation θ^{R}₁+8≦θ^{R}₂≦θ^{R}₁+18, more preferably satisfies an inequation θ^{R}₁+10≦θ^{R}₂≦θ^{R}₁+15.

The vapor deposition is preferably carried out under a condition so that the vapor deposition amount becomes larger than that of the step (2R1) and the vapor deposition amount becomes 10 to 25 nm, more preferably carried out under a condition so that the vapor deposition amount becomes 15 to 20 nm. The vapor deposition may be carried out while continuously changing the angle θ^{R}₂ (°) within a range satisfying the formula (e) under a condition so that the total vapor deposition amount becomes 10 to 25 nm. In the case of carrying out the step (2L2) to be described later after the step (2R2) and continuously changing the angle θ^{R}₂ (°), it is preferred to change the angle in a direction of reducing the angle.

### (Formation of Metal Layer of Second Cover Layer Side)

A metal layer 27 can be formed, as shown in FIG. 7, by carrying out, after the step (2L1), a step (2L2) of vapor-depositing aluminum from a direction V2 substantially perpendicular to the longitudinal direction L of each ridge 12 and at an angle θ^{L}₂ (°) satisfying the following formula (f) on the second side surface 18 side to the height direction H of the ridge 12 under a condition so that the vapor deposition amount becomes larger than that of the step (2L1).

θ^{L}₁+1≦θ^{L}₂≦θ^{L}₁20 (f)

The angle θ^{L}₂ (°) preferably satisfies an inequation θ^{L}₁+3≦θ^{L}₂≦θ^{L}₁+18, more preferably satisfies an inequation θ^{L}₁+5≦θ^{L}₂≦θ^{L}₁+15.

The vapor deposition is preferably carried out under a condition so that the vapor deposition amount becomes larger than that of the step (2L1) and the vapor deposition amount becomes 10 to 25 nm, more preferably carried out under a condition so that the vapor deposition amount becomes 15 to 20 nm. The vapor deposition may be carried out while continuously changing the angle θ^{L}₂ (°) within a range satisfying the formula (f) under a condition so that the total vapor deposition amount becomes 10 to 25 nm. In the case of carrying out the step (2L2) after the step (2R2) and continuously changing the angle θ^{L}₂ (°), it is preferred to change the angle in a direction of increasing the angle.

The metal layer 27 is formed by vapor-depositing aluminum so that no aluminum oxide is formed in the metal layer 27. Specifically, the metal layer is preferably formed under the vapor deposition conditions whereby when aluminum is vapor-deposited on a flat portion with a vapor deposition amount of 20 nm, a thin film of aluminum having a transmittance T (%) of less than 3% and a reflectance R (%) of more than 85% is formed.

### [Process for Producing a Wire-Grid Polarizer of Fourth Embodiment]

The wire-grid polarizer 10 of the fourth embodiment can be produced by adding the following step to the process of the first embodiment. It is a step (1L1) of forming a metal layer 27 on a surface of the second side surface 18 of each ridge 12 of the light-transmitting substrate 14 at an optional stage.

In the process of the fourth embodiment, explanation of the subject matter common to that of the process of the first embodiment is omitted.

### (Formation of Metal Layer on Second Cover Layer Side)

The metal layer 27 is preferably formed by carrying out a step (1L1) of vapor-depositing aluminum from a direction V2 substantially perpendicular to the longitudinal direction L of each ridge 12 and at an angle θ^{L}₁ (°) satisfying the following formula (g) on the second side surface 18 side to the height direction H of the ridge 12.

tan(θ^{L}₁±10)=(Pp−Dpb/2)/Hp (g)

The angle θ^{L}₁ (°) preferably satisfies an equation tan(θ^{L}₁±5)=(Pp−Dpb/2)/Hp.

The vapor deposition is preferably carried out under a condition so that the vapor deposition amount becomes from 5 to 25 nm, more preferably carried out under a condition so that the vapor deposition amount becomes 5 to 22 nm. The vapor deposition may be carried out while continuously changing the angle θ^{L}₁ (°) within a range satisfying the formula (g) under a condition so that the total vapor deposition amount becomes from 4 to 25 nm.

### [Process for Producing a Wire-Grid Polarizer of Fifth Embodiment]

The wire-grid polarizer 10 of the fifth embodiment can be produced in the same manner as the process of the fourth embodiment except that the metal layer 21 formed in step (1R1) is changed to a metal layer 22 and that the metal layer 27 formed in the step (1L1) is changed to a metal oxide layer 26.

### [Process for Producing a Wire-Grid Polarizer of Sixth Embodiment]

The wire-grid polarizer 10 of the sixth embodiment can be formed by adding the following step to the process of the first embodiment. It is a step (1L1) of forming a metal oxide layer 26 on a surface of the second side surface 18 of each ridge 12 of the light-transmitting substrate 14 at an optional stage.

In the process of the sixth embodiment, explanation of the subject matter common to the process of the first embodiment is omitted.

### (Formation of Metal Layer on Second Cover Layer Side)

The metal oxide layer 26 is, as shown in FIG. 7, preferably formed by carrying out a step (1L1) of vapor-depositing aluminum from a direction V2 substantially perpendicular to the longitudinal direction L of each ridge 12 and at an angle θ^{L}₁ (°) satisfying the following formula (h) on the second side surface 18 side to the height direction H of the ridge 12.

tan(θ^{L}₁±10)=(Pp−Dpb/2)/Hp (h)

The angle θ^{L}₁ (°) preferably satisfies an equation tan(θ^{L}₁±5)=(Pp−Dpb/2)/Hp.

The vapor deposition is preferably carried out under a condition so that the vapor deposition amount becomes from 4 to 25 nm, more preferably carried out under a condition so that the vapor deposition amount becomes 5 to 22 nm. The vapor deposition may be carried out while continuously changing the angle θ^{L}₁ (°) within a range satisfying the formula (h) under a condition so that the total vapor deposition amount becomes from 4 to 25 nm.

The angle θ^{R} (θ^{L}) in the process of the first to sixth embodiments may, for example, be adjusted by employing the following vapor deposition apparatus. It is a vapor deposition apparatus wherein the tilt of a light-transmittance substrate 14 disposed so as to face to a vapor deposition source can be adjusted so that the vapor deposition source is positioned on an extension line in a direction V1 (V2) substantially perpendicular to the longitudinal direction of each ridge 12 and at an angle of θ^{R} (θ^{L}) on the first side surface 16 (second side surface 18) side to the height direction H of the ridge 12.

### (Function and Effect)

In the process for producing a wire-grid polarizer of the present invention described above, since a cover layer comprising a metal layer and a metal oxide layer is formed to cover at least one side surface of each ridge on a light-transmitting substrate having a surface on which a plurality of ridges are formed in parallel with one another at a predetermined pitch via flat portions formed between the ridges, it is possible to produce a wire-grid polarizer having a high degree of polarization and a high p-polarized light transmittance.

Further, in the process for producing a wire-grid polarizer of the present invention, since the cover layer is formed so that the maximum value of the covering thickness from the half-height position to the bottom portion of each ridge is smaller than the maximum value of the covering thickness from the half-height position to the top position of the ridge, and since the metal oxide layer constituting a part of the cover layer is formed by vapor-depositing aluminum under the presence of oxygen so that oxygen defects are formed in the metal oxide layer, it is possible to produce a wire-grid polarizer having one surface (a surface on which the ridges are formed, that is a front surface) having a high s-polarized light reflectance, and having the other surface (a surface on which no ridge is formed, that is a rear surface) having a low s-polarized light reflectance.

### <Liquid Crystal Display Device>

The liquid crystal display device of the present invention comprises a liquid crystal panel comprising a pair of substrates and a liquid crystal layer sandwiched between the substrates; a backlight unit; and a wire-grid polarizer obtained by the process of the present invention, the wire-grid polarizer being disposed so that the surface on which the ridges are formed faces to the backlight unit, and that a surface on which no ridge is formed is on the viewer side of the liquid crystal display device.

The wire-grid polarizer may be disposed on one of the surfaces the liquid crystal panel and it is preferably disposed on the backlight unit side surface of the liquid crystal panel.

Further, the wire-grid polarizer may be disposed in a state that it is integrally formed with one of the pair of substrates of the liquid crystal panel as shown in e.g. FIG. 15 of JP-A-2006-139283, and the wire-grid polarizer is preferably integrally formed with the backlight unit side substrate of the liquid crystal panel.

Further, as described in e.g. FIG. 14 of Japanese Patent No. 4412388, the wire-grid polarizer may be disposed on the liquid crystal layer side of one of the pair of substrates of the liquid crystal panel, that is inside of the liquid crystal panel, and is preferably disposed on the liquid crystal layer side of a backlight unit side substrate of the pair of substrates of the liquid crystal panel.

The liquid crystal display device of the present invention preferably comprises an absorption type polarizer disposed on a surface of the liquid crystal panel opposite from the surface on which the wire-grid polarizer is disposed.

The absorption type polarizer is more preferably disposed on a surface of the liquid crystal panel opposite from the backlight unit-side surface.

FIG. 9 is a cross-sectional view showing an example of the liquid crystal display device of the present invention. A liquid crystal display device 30 comprises a liquid crystal panel 34 comprising a pair of substrates 31 and 32 and a liquid crystal layer 33 sandwiched between the substrates; a backlight unit 35; a wire-grid polarizer 10 obtained by the process of the present invention and pasted on a backlight unit 35 side surface of the liquid crystal panel; and an absorption type polarizer 36 pasted on a surface of the liquid crystal panel 34 opposite from the backlight unit 35 side surface.

Since the liquid crystal display device of the present invention described above has a wire-grid polarizer having a high degree of polarization and a high p-polarized light transmittance obtained by the process of the present invention, the liquid crystal display device has a high brightness.

Further, in the liquid crystal display device of the present invention, since a wire-grid polarizer having one surface (a surface on which ridges are formed, that is a front surface) having a high s-polarized light reflectance and the other surface (a surface on which no ridge is formed, that is a rear surface) having a low s-polarized light reflectance is disposed so that a surface of the polarizer on which the ridges are formed faces to the backlight unit and a surface on which no ridge is formed is on the viewer side of the liquid crystal display device, it is possible to suppress lowering of contrast.

### EXAMPLES

Now, the present invention will be described in further detail with reference to Examples, but, the present invention is not limited to these Examples. Examples 1 to 19 are Examples of the present invention, and Example 20 is a Comparative Example.

### (Dimensions of Ridge and Layers)

Dimensions of the ridge and the layers were each obtained by measuring the dimension of the ridge or the dimension of the layer on the ridge with respect to five ridges in a transmission electron microscopic image of a cross-section of the wire-grid polarizer, and averaging the five dimensions.

(p-Polarized Light Transmittance)

p-Polarized light transmittance was measured by using an UV-VIS spectrophotometer (V-7200 manufactured by JASCO Corporation). The measurement was carried out by setting a polarizer as an accessory of the instrument, between a light source and a wire-grid polarizer so that its absorptance axis becomes parallel with the longitudinal direction of fine metal wires of the wire-grid polarizer, and making a polarized light incident from a front surface side (a side on which ridges are formed) or a rear surface side (side on which no ridge is formed) of the wire-grid polarizer. Measurement wavelengths were 450 nm, 550 nm and 700 nm.

A sample showing a p-polarized light transmittance of at least 70% is designated as S, a sample showing that of at least 60% and less than 70% is designated as A, a sample showing that of at least 50% and less than 60% is designated as B, and a sample showing that of less than 50% is designated as X.

(s-Polarized Light Reflectance)

s-Polarized light reflectance was measured by using an UV-VIS spectrophotometer (V-7200 manufactured by JASCO Corporation). The measurement was carried out by setting a polarizer as an accessory of the instrument, between a light source and a wire-grid polarizer so that its absorptance axis becomes perpendicular to the longitudinal direction of fine metal wires of the wire-grid polarizer, and making a polarized light incident at an angle of 5° to the front surface or the rear surface of the wire-grid polarizer. The measurement wavelengths were 450 nm, 550 nm and 700 nm. A sample showing a front surface s-polarized light reflectance of at least 80% is designated as S, and a sample showing that of at least 70% and less than 80% is designated as A. Further, a sample showing a rear surface s-polarized light reflectance of less than 20% is designated as S, a sample showing that of at least 20% and less than 40% is designated as A, a sample showing that of at least 40% and less than 50% is designated as B, and a sample showing that of at least 50% is designated as X.

### (Degree of Polarization)

The degree of polarization was calculated according to the following formula (n).

Degree of polarization=((Tp−Ts)/(Tp+Ts))^{0.5}×100 (n)

wherein Tp is a front surface p-polarized light transmittance and Ts is a front surface s-polarized light transmittance.

A sample showing a degree of polarization of at least 99.5% is designated as S, a sample showing that of at least 99.0% and less than 99.5% is designated as A, a sample showing that of at least 98.0% and less than 99.0% is designated as B, and a sample showing that of less than 98.0% is designated as X.

### (Brightness)

Brightness was measured by the following method.

On an LED side light type backlight unit of 2 inch size, a wire-grid polarizer and a liquid crystal cell were piled in this order. The wire-grid polarizer was disposed so that its rear surface side (a side on which no ridge is formed) faces to the liquid crystal panel. As the liquid crystal panel, one whose only upper side was provided with an iodine type polarizer was employed. In a dark room, the backlight unit and the liquid crystal panel were turned on. The entire screen of the liquid crystal panel was turned to be white, and 10 minutes after the turning on, the center brightness B31 was measured by using a luminance colorimeter (BM-5AS manufactured by TOPCON CORPORATION) with a view angle of 0.1°. Subsequently, the entire screen of the liquid crystal panel was turned to be black, and a brightness B32 in this state was measured.

By using the same backlight unit, on the backlight unit, a liquid crystal panel having upper and lower surfaces provided with respective iodine type polarizers was overlaid. In a dark room, the backlight unit and the liquid crystal panel were turned on, and a center brightness B21 in a state that the entire screen of the liquid crystal panel was turned to be white, was measured in the same manner. By using the values obtained in the above measurements, a brightness improvement ratio was obtained according to the following formula (o).

Brightness improvement ratio=(B31−B21)/B21×100 (o)

A sample showing a brightness improvement ratio of at least 25% is designated as S, a sample showing that of at least 20% and less than 25% is designated as A, a sample showing that of at least 15% and less than 20% is designated as B, and a sample showing that of less than 15% is designated as X.

### (Contrast)

By using the values obtained in the above measurements, the contrast was obtained according to the following formula (p).

Contrast=B31/B32 (p)

A sample showing a contrast of at least 500 is designated as S, a sample showing that of at least 300 and less than 500 is designated as A, a sample showing that of at least 100 and less than 300 is designated as B, and a sample showing that of less than 100 is designated as X.

### (Preparation of Photocurable Composition)

60 g of a monomer 1 (NK ester A-DPH, dipentaerythritol hexaacrylate, manufactured by Shin-Nakamura Chemical Co., Ltd.), 40 g of a monomer 2 (NK ester A-NPG, neopentyl glycol diacrylate, manufactured by Shin-Nakamura Chemical Co., Ltd.), 4.0 g of a photopolymerization initiator (IRGACURE 907, manufactured by Ciba Specialty Chemicals), 0.1 g of fluorosurfactant (cooligomer of fluoroacrylate (CH₂═CHCOO(CH₂)₂(CF₂)₈F) and butyl acrylate, manufactured by Asahi Glass Company, Limited, fluorine content: about 30 mass %, mass-average molecular weight: about 3,000), 1.0 g of a polymerization inhibitor (Q1301, manufactured by Wako Pure Chemical Industries, Ltd.) and 65.0 g of cyclohexanone, were put in a four-port flask of 1,000 mL to which a stirrer and a cooling pipe are attached.

In a state that inside of the flask was set at room temperature while light is shielded, stirring was carried out for 1 hour to homogenize the content. Subsequently, while the content of the flask was being stirred, 100 g of a colloidal silica (solid state content: 30 g) was gradually added, and the content of the flask was stirred for 1 hour in a state that inside of the flask was set to room temperature while light is shielded, to homogenize the content. Subsequently, 340 g of cyclohexanone was added, and the content of the flask was stirred for 1 hour in a state that inside of the flask was set to room temperature while light is shielded, to obtain a solution of photocurable composition 1.

### (Preparation of Light-Transmitting Substrate)

The photocurable composition 1 was applied on a surface of a high-transmitting polyethylene terephthalate (PET) film (Teijin Tetron O3, manufactured by Teijin DuPont, 100 mm×100 mm) having a thickness of 100 μm, by a spin coating method, to form a coating film of the photocurable composition 1 having a thickness of 5 μm. A quartz mold (area: 150 mm×150 mm, pattern area: 100 mm×100 mm, groove pitch Pp: 140 nm, width of top portion of groove Dpb: 60 nm, width of bottom portion of groove Dpt: 20 nm, groove depth Hp: 200 nm, groove length: 100 mm, cross-sectional shape of groove: substantially trapezoidal shape) having a plurality of grooves formed so as to be parallel with one another at a predetermined pitch with flat portions formed between the grooves, was pressed against the coating film of the photocurable composition 1 at 25° C. with 0.5 MPa (gauge pressure) so that the grooves contact with the coating film of the photocurable composition 1.

While the state that the quartz mold was pressed against the coating film of the photocurable composition 1 was maintained, light of a high pressure mercury lamp (frequency: 1.5 kHz to 2.0 kHz, peak wavelengths: 255 nm, 315 nm and 365 nm, radiation energy at 365 nm: 1,000 mJ) was radiated to the photocurable composition 1 from the PET film side for 15 seconds, to cure the photocurable composition 1, and subsequently, the quartz mold was slowly separated from the light-transmitting substrate. By this method, a light-transmitting substrate 1 (ridge pitch Pp: 140 nm, width of bottom portion of ridge Dpb: 60 nm, width of top portion of ridge Dpt: 20 nm, ridge height Hp: 200 nm, θ1 and θ2: 84°) having a plurality of ridges corresponding to the grooves of the quartz mold and flat portions between the ridges, was prepared.

### (Condition-Setting of Vapor Deposition Conditions)

(i) In a vacuum vapor deposition apparatus (SEC-16CM, manufactured by Showa Shinku Co., Ltd.), a vacuum vapor deposition source (aluminum) was heated to vapor-deposit aluminum on a flat alkali-free glass substrate for 20 seconds to form a thin film.

(ii) The thickness of the thin film was measured by a film thickness monitor using a quartz oscillator as a film thickness sensor, and the film thickness was divided by the vapor deposition time to calculate a vapor deposition speed, and as a result, it was 1.8 nm/sec.

(iii) In the same vacuum vapor deposition as that of the procedure (i), under the condition of oxygen introduction amount: 0 sccm, the vapor deposition source (aluminum) was heated under the same heating condition as that of the procedure (i) to vapor-deposit aluminum on a flat alkali-free glass substrate for a vapor deposition time whereby the vapor deposition amount becomes 20 nm, to form a thin film.

(iv) The transmittance (T) and the reflectance (R) of the thin film were measured by using an UV-visible spectrophotometer. It was confirmed that a thin film of aluminum (Al) having a T of 2.9% and an R of 86% was formed. Table 1 shows the results.

(v) While changing the oxygen introduction amount to the values shown in Table 1, the procedures (iii) and (iv) were repeated. It was confirmed that a thin film made of an aluminum oxide (Al₂O₃₋ₓ) having oxygen defects satisfying the formulae (j) to (m) was formed.

(vi) While changing heating conditions of the vapor deposition source (aluminum), the procedures (i) to (v) were repeated. With respect to each of the cases under the vapor deposition speed of 1.0 nm/sec and that of 0.3 nm/sec, the results under the oxygen introduction amount shown in Table 1 were shown in Table 1. It was confirmed that when the vapor deposition speed was 0.3 nm/sec and the oxygen introduction amount was 10 sccm, a thin film of aluminum oxide (Al₂O₃) having no oxygen defect and having a T of 91% and an R of 8% was formed. Further, under other conditions, it was confirmed that a thin film made of an aluminum oxide (Al₂O₃₋ₓ) having oxygen defects satisfying the formulae (j) to (m) was formed.

The graph of FIG. 10 shows the relation between oxygen introduction amount and transmittance (T) at each vapor deposition speed.

The graph of FIG. 11 shows the relation between oxygen introduction amount and reflectance (R) at each vapor deposition speed.

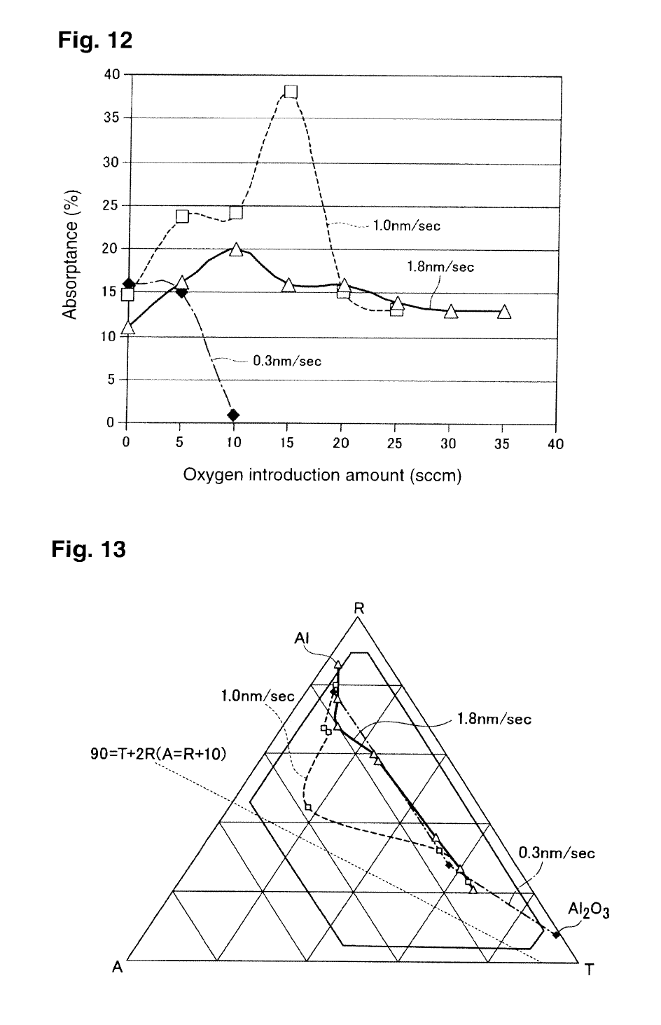

The graph of FIG. 12 shows the relation between oxygen introduction amount and absorptance (A) at each vapor deposition speed.

The triangle diagram of FIG. 13 shows the relation between transmittance (T), reflectance (R) and absorptance (A) at each vapor deposition speed.

### Example 1

### Formation of Cover Layer

Employing a vacuum vapor deposition apparatus (SEC-16CM, manufactured by Showa Shinku Co., Ltd.) wherein the tilt of a light-transmitting substrate 1 facing to a vapor deposition source can be adjusted, aluminum was vapor-deposited to cover the ridges of the light-transmitting substrate by an oblique vapor deposition method, to form the cover layer, thereby to obtain a wire-grid polarizer shown in the first embodiment (FIG. 1) and having a rear surface on which a PET film was pasted. Here, a first vapor deposition was carried out under the vapor deposition conditions (vapor deposition speed and oxygen supply amount) shown in Table 1 and the direction V, the angle θ^{R(L)} and the vapor deposition amount t shown in Table 2, and a second vapor deposition was carried out under the vapor deposition conditions (vapor deposition speed and oxygen supply amount) shown in Table 1 and the direction V, the angle θ^{R(L)} and the vapor deposition amount t shown in Table 2. The vapor deposition amount t is the thickness of a metal layer or a metal oxide layer formed by the vapor deposition on a flat portion wherein no ridge is formed, and the vapor deposition amount t was measured by a film thickness monitor employing a crystal oscillator as the film thickness sensor.

### Example 2

A wire-grid polarizer shown in the second embodiment (FIG. 2) was obtained in the same manner as Example 1 except that the vapor deposition conditions (vapor deposition speed and oxygen supply amount) were changed as shown in Table 1 and the direction V, the angle θ^{R(L)} and the vapor deposition amount t were changed as shown in Table 2 in the first and the second vapor depositions.

### Examples 3 to 6

A wire-grid polarizer shown in the first embodiment (FIG. 1) was obtained in the same manner as Example 1 except that the vapor deposition conditions (vapor deposition speed and oxygen supply amount) were changed as shown in Table 1 and the direction V, the angle θ^{R(L)} and the vapor deposition amount t were changed as shown in Table 2 in the first and the second vapor depositions.

### Examples 7 to 11

A wire-grid polarizer shown in the third embodiment (FIG. 3) was obtained in the same manner as Example 1 except that the number of vapor depositions was changed to the number shown in Table 2, and in the vapor depositions, the vapor deposition conditions (vapor deposition speed and oxygen supply amount), the direction V, the angle θ^{R(L)} and the vapor deposition amount t were changed as shown in Table 2.

### Example 12

A wire-grid polarizer shown in the fourth embodiment (FIG. 4) was obtained in the same manner as Example 1 except that the number of vapor depositions was changed to the number shown in Table 2, and in the vapor depositions, the vapor deposition conditions (vapor deposition speed and oxygen supply amount) were changed as shown in Table 1 and the direction V, the angle θ^{R(L)} and the vapor deposition amount t were changed as shown in Table 2.

### Example 13

The wire-grid polarizer shown in the fifth embodiment (FIG. 5) was obtained in the same manner as Example 1 except that the number of vapor depositions was changed to the number shown in Table 2, and in the vapor depositions, the vapor deposition conditions (vapor deposition speed and oxygen supply amount) were changed as shown in Table 1 and the direction V, the angle θ^{R(L)} and the vapor deposition amount t were changed as shown in Table 2.

### Example 14

The wire-grid polarizer shown in the sixth embodiment (FIG. 6) was obtained in the same manner as Example 1 except that the number of vapor depositions was changed to the number shown in Table 2, and in the vapor depositions, the vapor deposition conditions (vapor deposition speed and oxygen supply amount) were changed as shown in Table 1 and the direction V, the angle θ^{R(L)} and the vapor deposition amount t were changed as shown in Table 2.

### Examples 15 to 19

The wire-grid polarizer shown in the third embodiment (FIG. 3) was obtained in the same manner as Example 11 except that in the vapor depositions, the vapor deposition conditions (vapor deposition speed and oxygen supply amount) were changed as shown in Table 2 and the direction V, the angle θ^{R(L)} and the vapor deposition amount t were changed as shown in Table 2.

### Example 20

The wire-grid polarizer (wherein the metal oxide layer does not satisfy the formula (j)) shown in the third embodiment (FIG. 3) was obtained in the same manner as Example 1 except that the number of vapor depositions was changed to the number shown in Table 2, and in the vapor depositions, the vapor deposition conditions (vapor deposition speed and oxygen supply amount) were changed as shown in Table 1 and the direction V, the angle θ^{R(L)} and the vapor deposition amount t were changed as shown in Table 2.

### [Measurement and Evaluation]

With respect to each of the wire-grid polarizers of Examples 1 to 20, the dimensions of the cover layer was measured. Table 3 shows the results. Further, with respect to each of the wire-grid polarizers of Examples 1 to 20, the transmittance, the reflectance, the degree of polarization, the brightness and the contrast were measured. Table 4 shows the results.

TABLE 1

| | Vapor | Oxygen | | | | |
|---|---|---|---|---|---|---|
| Vapor | deposition | introduction | | | | |
| deposition | speed | amount | Transmittance (T) | Reflectance (R) | Absorptance (A) | |
| conditions | (nm/sec) | (sccm) | (%) | (%) | (%) | Film material |
| (1) | 1.8 | 0 | 2.9 | 86 | 11.1 | Al |
| (2) | 1.8 | 5 | 7.9 | 76 | 16.1 | Al₂O₃₋ₓ |
| (3) | 1.8 | 10 | 12 | 68 | 20 | Al₂O₃₋ₓ |
| (4) | 1.8 | 15 | 24 | 60 | 16 | Al₂O₃₋ₓ |
| (5) | 1.8 | 20 | 26 | 58 | 16 | Al₂O₃₋ₓ |
| (6) | 1.8 | 25 | 50 | 36 | 14 | Al₂O₃₋ₓ |
| (7) | 1.8 | 30 | 60 | 27 | 13 | Al₂O₃₋ₓ |
| (8) | 1.8 | 35 | 66 | 21 | 13 | Al₂O₃₋ₓ |
| (9) | 1.0 | 0 | 5.4 | 80 | 14.6 | Al₂O₃₋ₓ |
| (10) | 1.0 | 5 | 9.4 | 67 | 23.6 | Al₂O₃₋ₓ |
| (11) | 1.0 | 10 | 10 | 66 | 24 | Al₂O₃₋ₓ |
| (12) | 1.0 | 15 | 18 | 44 | 38 | Al₂O₃₋ₓ |
| (13) | 1.0 | 20 | 53 | 32 | 15 | Al₂O₃₋ₓ |
| (14) | 1.0 | 25 | 64 | 23 | 13 | Al₂O₃₋ₓ |
| (15) | 0.3 | 0 | 6 | 78 | 16 | Al₂O₃₋ₓ |
| (16) | 0.3 | 5 | 57 | 28 | 15 | Al₂O₃₋ₓ |
| (17) | 0.3 | 10 | 91 | 8 | 1 | Al₂O₃ |
| (18) | 1.8 | 5 | 8.3 | 73 | 18.7 | Al₂O₃₋ₓ |
| (19) | 0.3 | 5 | 55 | 25 | 20 | Al₂O₃₋ₓ |
| (20) | 1.0 | 10 | 10 | 57 | 33 | Al₂O₃₋ₓ |
| (21) | 1.0 | 0 | 7.2 | 77 | 15.8 | Al₂O₃₋ₓ |
| (22) | 1.0 | 10 | 11 | 66 | 23 | Al₂O₃₋ₓ |

TABLE 2

| | Vapor | | Angle | Vapor | Vapor | | Angle | Vapor |
|---|---|---|---|---|---|---|---|---|
| | deposition | | θ^{R(L)} | deposition | deposition | | θ^{R(L)} | deposition |
| Ex. | conditions | Direction V | (°) | amount t (nm) | conditions | Direction V | (°) | amount t (nm) |
| | First vapor deposition | | | | Second vapor deposition | | | |
| 1 | (12) | V1 | 30 | 10 | (1) | V1 | 45 | 35 |
| 2 | (1) | V1 | 30 | 10 | (9) | V1 | 45 | 35 |
| 3 | (8) | V1 | 30 | 15 | (1) | V1 | 45 | 35 |
| 4 | (15) | V1 | 30 | 20 | (1) | V1 | 45 | 35 |
| 5 | (10) | V1 | 30 | 10 | (1) | V1 | 45 | 50 |
| 6 | (7) | V1 | 30 | 10 | (1) | V1 | 45 | 65 |
| 7 | (2) | V1 | 30 | 10 | (2) | V2 | 30 | 10 |
| 8 | (18) | V1 | 30 | 10 | (18) | V2 | 30 | 10 |
| 9 | (6) | V1 | 30 | 10 | (6) | V2 | 30 | 10 |
| 10 | (5) | V1 | 30 | 10 | (5) | V2 | 30 | 10 |
| 11 | (4) | V1 | 30 | 10 | (4) | V2 | 30 | 10 |
| 12 | (14) | V1 | 30 | 10 | (1) | V2 | 30 | 10 |
| 13 | (1) | V1 | 30 | 10 | (3) | V2 | 30 | 10 |
| 14 | (19) | V1 | 30 | 10 | (20) | V2 | 30 | 10 |
| 15 | (21) | V1 | 30 | 10 | (21) | V2 | 30 | 10 |
| 16 | (22) | V1 | 30 | 10 | (22) | V2 | 30 | 10 |
| 17 | (12) | V1 | 30 | 10 | (12) | V2 | 30 | 10 |
| 18 | (13) | V1 | 30 | 10 | (13) | V2 | 30 | 10 |
| 19 | (16) | V1 | 30 | 10 | (16) | V2 | 30 | 10 |
| 20 | (17) | V1 | 30 | 10 | (17) | V2 | 30 | 10 |
| | Third vapor deposition | | | | Fourth vapor deposition | | | |
| 1 | — | — | — | — | — | — | — | — |
| 2 | — | — | — | — | — | — | — | — |
| 3 | — | — | — | — | — | — | — | — |
| 4 | — | — | — | — | — | — | — | — |
| 5 | — | — | — | — | — | — | — | — |
| 6 | — | — | — | — | — | — | — | — |
| 7 | (1) | V1 | 45 | 20 | (1) | V2 | 45 | 20 |
| 8 | (1) | V1 | 45 | 15 | (1) | V2 | 45 | 15 |
| 9 | (1) | V1 | 40 | 20 | (1) | V2 | 40 | 20 |
| 10 | (1) | V1 | 40 | 15 | (1) | V2 | 40 | 15 |
| 11 | (1) | V1 | 40 | 15 | (1) | V2 | 35 | 15 |
| 12 | (1) | V1 | 45 | 35 | — | — | — | — |
| 13 | (1) | V1 | 45 | 35 | — | — | — | — |
| 14 | (1) | V1 | 45 | 35 | — | — | — | — |
| 15 | (1) | V1 | 40 | 15 | (1) | V2 | 35 | 15 |
| 16 | (1) | V1 | 40 | 15 | (1) | V2 | 35 | 15 |
| 17 | (1) | V1 | 40 | 15 | (1) | V2 | 35 | 15 |
| 18 | (1) | V1 | 40 | 15 | (1) | V2 | 35 | 15 |
| 19 | (1) | V1 | 40 | 15 | (1) | V2 | 35 | 15 |
| 20 | (1) | V1 | 45 | 20 | (1) | V2 | 45 | 20 |

TABLE 3

| | | | | | Metal layer | | | | | | | | |
|---|---|---|---|---|---|---|---|---|---|---|---|---|---|
| | | | | | | | | | | | Second side | | |
| | Light-transmitting substrate | | | | First side surface | | | | | | surface | | |
| | Pp | Dpb | Dpt | Hp | Da1 | Dr1 | H1 | H2 | | | Da2 | Dr2 | |
| Ex. | (nm) | (nm) | (nm) | (nm) | (nm) | (nm) | (nm) | (nm) | H1/Hp | H2/Hp | (nm) | (nm) | Embodiment |
| 1 | 140 | 60 | 20 | 200 | 10 | 45 | 45 | 200 | 0.23 | 1 | — | — | 1 |
| 2 | 140 | 60 | 20 | 200 | 10 | 45 | 45 | 200 | 0.23 | 1 | — | — | 2 |
| 3 | 140 | 60 | 20 | 200 | 15 | 50 | 47 | 200 | 0.24 | 1 | — | — | 1 |
| 4 | 140 | 60 | 20 | 200 | 20 | 55 | 50 | 200 | 0.25 | 1 | — | — | 1 |
| 5 | 140 | 60 | 20 | 200 | 10 | 60 | 65 | 200 | 0.33 | 1 | — | — | 1 |
| 6 | 140 | 60 | 20 | 200 | 10 | 75 | 87 | 200 | 0.44 | 1 | — | — | 1 |
| 7 | 140 | 60 | 20 | 200 | 10 | 30 | 60 | 200 | 0.30 | 1 | 10 | 30 | 3 |
| 8 | 140 | 60 | 20 | 200 | 10 | 25 | 50 | 200 | 0.25 | 1 | 10 | 25 | 3 |
| 9 | 140 | 60 | 20 | 200 | 10 | 30 | 55 | 200 | 0.28 | 1 | 10 | 30 | 3 |
| 10 | 140 | 60 | 20 | 200 | 10 | 25 | 46 | 200 | 0.23 | 1 | 10 | 25 | 3 |
| 11 | 140 | 60 | 20 | 200 | 10 | 25 | 44 | 200 | 0.22 | 1 | 10 | 25 | 3 |
| 12 | 140 | 60 | 20 | 200 | 10 | 45 | 50 | 200 | 0.25 | 1 | 10 | — | 4 |
| 13 | 140 | 60 | 20 | 200 | 10 | 45 | 50 | 200 | 0.25 | 1 | 10 | — | 5 |
| 14 | 140 | 60 | 20 | 200 | 10 | 45 | 50 | 200 | 0.25 | 1 | 10 | — | 6 |
| 15 | 140 | 60 | 20 | 200 | 10 | 25 | 44 | 200 | 0.22 | 1 | 10 | 25 | 3 |
| 16 | 140 | 60 | 20 | 200 | 10 | 25 | 44 | 200 | 0.22 | 1 | 10 | 25 | 3 |
| 17 | 140 | 60 | 20 | 200 | 10 | 25 | 44 | 200 | 0.22 | 1 | 10 | 25 | 3 |
| 18 | 140 | 60 | 20 | 200 | 10 | 25 | 44 | 200 | 0.22 | 1 | 10 | 25 | 3 |
| 19 | 140 | 60 | 20 | 200 | 10 | 25 | 44 | 200 | 0.22 | 1 | 10 | 25 | 3 |
| 20 | 140 | 60 | 20 | 200 | 10 | 30 | 60 | 200 | 0.30 | 1 | 10 | 30 | (3) |

TABLE 4

| Wavelength | |
|---|---|
| 450 nm | 550 nm |

| | p-Polarized light | | s-Polarized light | | | p-Polarized light | | s-Polarized light | | |
|---|---|---|---|---|---|---|---|---|---|---|
| | transmittance | | reflectance | | Degree | transmittance | | reflectance | | Degree |
| | Front | Rear | Front | Rear | of | Front | Rear | Front | Rear | of |
| Ex. | surface | surface | surface | surface | polarization | surface | surface | surface | surface | polarization |
| 1 | S | S | A | S | A | S | S | S | S | A |
| 2 | S | S | A | A | A | S | S | S | S | S |
| 3 | S | S | S | A | A | S | S | S | A | A |
| 4 | S | S | S | A | A | S | S | S | A | S |
| 5 | A | A | S | S | A | S | S | S | S | S |
| 6 | A | A | S | S | S | A | A | S | S | S |
| 7 | B | B | S | S | S | B | B | S | S | S |
| 8 | A | A | S | S | S | A | A | S | S | S |
| 9 | B | B | S | S | S | B | B | S | S | S |
| 10 | A | A | S | S | S | A | A | S | S | S |
| 11 | A | A | S | S | S | A | A | S | S | S |
| 12 | B | B | S | S | S | B | B | S | S | S |
| 13 | B | B | S | S | S | B | B | S | S | S |
| 14 | B | B | S | S | S | B | B | S | S | S |
| 15 | A | A | S | S | S | S | S | S | A | S |
| 16 | A | A | S | S | S | S | S | S | S | S |
| 17 | A | A | S | S | S | S | S | S | S | S |
| 18 | A | A | S | S | S | A | A | S | S | S |
| 19 | A | A | S | S | S | A | A | S | S | S |
| 20 | A | A | S | X | B | A | A | S | X | B |

Wavelength
700 nm

| | | | |
|---|---|---|---|
| p-Polarized light | s-Polarized light | | |
| transmittance | reflectance | Degree | Brightness |

| | Front | Rear | Front | Rear | of | improvement | |
|---|---|---|---|---|---|---|---|
| Ex. | surface | surface | surface | surface | polarization | ratio | Contrast |
| 1 | S | S | S | S | A | S | A |
| 2 | S | S | A | S | S | A | A |
| 3 | S | S | S | A | S | S | A |
| 4 | S | S | S | A | S | S | A |
| 5 | S | S | S | A | S | S | A |
| 6 | S | S | S | A | S | S | S |
| 7 | B | B | S | S | S | S | S |
| 8 | A | A | S | S | S | S | S |
| 9 | B | B | S | S | S | S | S |
| 10 | A | A | S | S | S | S | S |
| 11 | A | A | S | S | S | S | S |
| 12 | A | A | S | S | S | S | A |
| 13 | A | A | S | S | S | S | S |
| 14 | A | A | S | S | S | S | A |
| 15 | S | S | S | A | S | S | S |
| 16 | S | S | S | S | S | S | S |
| 17 | S | S | S | S | S | S | S |
| 18 | A | A | S | S | S | S | S |
| 19 | A | A | S | S | S | S | S |
| 20 | A | A | S | X | A | S | B |

### INDUSTRIAL APPLICABILITY

The wire-grid polarizer obtained by the process of the present invention is useful as a polarizer, a polarizing glass etc. for image display devices such as liquid crystal display devices, rear projection TVs or front projectors.

### REFERENCE SYMBOLS

10: wire-grid polarizer
12: ridge
13: flat portion
14: light-transmitting substrate
16: first side surface
18: second side surface
19: top portion
20: first cover layer
21: metal oxide layer
22: metal layer
25: second cover layer
26: metal oxide layer
27: metal layer
30: liquid crystal display device
31: substrate
32: substrate
33: liquid crystal layer
34: liquid crystal panel
35: backlight unit
36: absorber type polarizer

What is claimed is:

1. A process for producing a wire-grid polarizer;
the wire-grid polarizer comprising:
a light-transmitting substrate having a surface on which a plurality of ridges are formed in parallel with one another at a predetermined pitch with flat portions formed between the ridges; and
a cover layer comprising a metal layer and a metal oxide layer and covering at least one side surface of each ridge, the maximum value of the covering thickness of the cover layer in a region from a half-height position to the bottom portion of the ridge being smaller than the maximum value of the covering thickness of the cover layer in a region from the half-height position to the top portion of the ridge;
the process comprising:
forming the metal layer by vapor-depositing aluminum so that no oxide is formed in the metal layer; and
forming the metal oxide layer by vapor-depositing aluminum under the presence of oxygen so that oxygen defects are formed in the metal oxide layer.

2. The process for producing a wire-grid polarizer according to claim 1, which comprises:
a step (1R1) of vapor-depositing aluminum from a direction substantially perpendicular to the longitudinal direction of each ridge and at an angle θ^{R}₁ (°) satisfying the following formula (a) on a first side surface side to the height direction of the ridge to form the metal oxide layer or the metal layer; and
a step (1R2) after the step (1R1), of vapor-depositing aluminum from a direction substantially perpendicular to the longitudinal direction of each ridge and at an angle θ^{R}₂ (°) satisfying the following formula (b) on the first side surface side to the height direction of the ridge under a condition whereby the vapor deposition amount becomes larger than that of the step (1R1), to form the metal layer or the metal oxide layer:
tan(θ^{R}₁±10)=(Pp−Dpb/2)/Hp (a)
θ^{R}₁+3≦θ^{R}₂≦θR₁+30 (b)
where Pp is the pitch of the ridges, Dpb is the width of the bottom portion of each ridge, and Hp is the height of each ridge.

3. The process for producing a wire-grid polarizer according to claim 2, wherein the step (1R1) is carried out under a condition whereby the vapor deposition amount becomes 4 to 25 nm, and the step (1R2) is carried out under a condition whereby the vapor deposition amount becomes 25 to 70 nm.

4. The process for producing a wire-grid polarizer according to claim 1, wherein the cover layer covers two side surfaces of each ridge, and the maximum value of the covering thickness of the cover layer in a region from the half-height position to the bottom portion of each ridge is smaller than the maximum value of the covering thickness of the cover layer in a region from the half-height position to the top portion of the ridge in each of the two side surfaces.

5. The process for producing a wire-grid polarizer according to claim 4, which comprises:
a step (2R1) of vapor-depositing aluminum from a direction substantially perpendicular to the longitudinal direction of each ridge and at an angle θ^{R}₁ (°) satisfying the following formula (c) on the first side surface side to the height direction of the ridge to form the metal oxide layer or the metal layer;
a step (2L1) of vapor-depositing aluminum from a direction substantially perpendicular to the longitudinal direction of the ridge and at an angle θ^{L}₁ (°) satisfying the following formula (d) on the second side surface side to the height direction of the ridge to form the metal oxide layer or the metal layer;
a step (2R2) after the step (2R1), of vapor-depositing aluminum from a direction substantially perpendicular to the longitudinal direction of the ridge and at an angle θ^{R}₂ (°) satisfying the following formula (e) on the first side surface side to the height direction of the ridge under a condition whereby the vapor deposition amount becomes larger than that of the step (2R1) to form the metal layer or the metal oxide layer; and
a step (2L2) after the step (2L1), of vapor-depositing aluminum from a direction substantially perpendicular to the longitudinal direction of the ridge and at an angle θ^{R}₂ (°) satisfying the following formula (f) on the second side surface side to the height direction of the ridge under a condition whereby the vapor deposition amount becomes larger than that of the step (2L1), to form the metal layer or the metal oxide layer:
tan(θ^{R}₁±10)=(Pp−Dpb/2)/Hp (c)
tan(θ^{L}₁±10)=(Pp−Dpb/2)/Hp (d)
θ^{R}₁+3≦θ^{R}₂≦θ^{R}₁+20 (e)
θ^{L}₁1+1≦θ^{L}₂≦θ^{L}₁+20 (f)
where Pp is the pitch of the ridges, Dpb is the width of the bottom portion of each ridge, and Hp is the height of each ridge.

6. The process for producing a wire-grid polarizer according to claim 5, wherein the step (2R1) and the step (2L1) are carried out under conditions whereby the vapor deposition amounts become 4 to 25 nm, and the step (2R2) and the step (2L2) are carried out under conditions whereby the vapor deposition amounts become 10 to 25 nm.

7. The process for producing a wire-grid polarizer according to claim 1, wherein the formation of the metal oxide layer is carried out under a vapor deposition condition whereby a thin film having a transmittance T (%) and a reflectance R(%) satisfying the following formulae (j) to (m) is formed when aluminum is vapor-deposited with a vapor deposition amount of 20 nm on a flat portion:
3≦T≦90 (j)
5≦R≦90 (k)
50≦T+R≦97 (l)
90≦T+2R (m).

8. The process for producing a wire-grid polarizer according to claim 1, wherein the cross-sectional shape of the ridge perpendicular to the longitudinal direction of the ridge is a shape having a width narrowing from the bottom portion toward the top portion of the ridge.

9. The process for producing a wire-grid polarizer according to claim 8, wherein the cross-sectional shape of the ridge perpendicular to the longitudinal direction of the ridge is a triangle or a trapezoid.

10. The process for producing a wire-grid polarizer according to claim 1, wherein the ridge is made of a photocurable resin or a thermoplastic resin and is formed by an imprinting method.
